(19) United States
(12) Patent Application Publication
(10) Pub. No.: US 2015/0095054 A1
(43) Pub. Date: Apr. 2, 2015

(54) MONITORING SYSTEMS AND METHOD

(71) Applicant: NewCare Solutions, LLC, Wexford, PA (US)

(72) Inventors: WILLIAM KAIGLER, WEXFORD, PA (US); TOM KERR, MURRYSVILLE, PA (US); CHRISTIAN KEBEKUS, SEWICKLEY, PA (US)

(21) Appl. No.: 14/500,114

(22) Filed: Sep. 29, 2014

Related U.S. Application Data
(60) Provisional application No. 61/884,311, filed on Sep. 30, 2013.

(51) Int. Cl. G06F 19/00

(52) U.S. Cl. CPC G06F 19/3418; G06F 19/327
USPC 705/2

(57) ABSTRACT

A system for monitoring a plurality of persons in an assisted living facility includes a local system in the assisted living facility. The local system includes a plurality of sensor systems. Each of the plurality of sensor systems is adapted to monitor changes in state of at least one monitored system caused by activity or lack of activity of at least one of the plurality of persons. The plurality of sensor systems include a plurality of presence sensors adapted to determine at least the presence or the absence of each one of the plurality of persons on a bed thereof or on a wheelchair thereof. The local system further includes a local communication device in communicative connection with each of the plurality of sensor systems to receive data from each of the plurality of sensor systems. The system further includes a remote system in communication with the local communication device. The remote system includes a processing system to process data from the plurality of sensor systems based upon predetermined rules. The remote system is adapted to provide an alert to at least one caregiver including at least one of (i) a fall alert and (ii) a condition alert related to at least one metric of bed use determined by the remote system and related to a potential change in condition of one of the plurality of persons.

### CROSS-REFERENCE TO RELATED APPLICATIONS

This application claims benefit of U.S. Provisional Patent Application Ser. No. 61/884,311, filed Sep. 30, 2013, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

A number of methods, devices and systems are available to monitor the wellbeing of a person such as a person residing in an assisted living environment, a skilled care facility, a nursing home, a memory care unit environment, a hospital facility and the like (sometimes referred to herein collectively as an “assisted living environment or facility”). Falls which occur upon a patient getting out of bed are a particular concern in such environments or facilities. Current methods of monitoring residents include, for example, one or more of, manual and periodic checks, bed alarms, nurse/assistance call buttons and emergency response devices. However, there are drawbacks associated with each of these methods.

For example, manual/periodic checks are labor intensive and time consuming. Manual/periodic checks may also be ineffective in many situations because they are only spot checks. Moreover, they disrupt the quality of sleep for the resident and distract the caregiver by forcing the caregiver to check residents who are asleep while another resident may be in need of help (for example, after a fall). Periodic checks are also primarily a reactive method of, for example, managing falls. In that regard, in many cases, the physical checks are too late to prevent a fall, but rather aid in helping a resident who has already fallen.

Many currently available audible bed alarms are loud and may include lights that disturb other residents in the facility. A number of studies have shown that audible alarms, especially in facilities caring for residents with dementia, often cause agitation and confusion, leading to an increase in incidents and a decrease in quality of life. Moreover, such bed alarms and associated monitoring devices operate independently and, as such, if an alarm/monitoring system become disconnected, unplugged or stops working for any reason, the caregiver(s) are not informed and must independently discover the problem.

Nurse/assistance call buttons and emergency response pendants may not be reliable because they require activation by the resident. Residents suffering from mental impairment such as dementia, do not reliably press the activation button when they need help or may not have the device accessible to them in the case of an incident. Residents also may intensely value their independence, and many times will not press the button unless the need for help is acute. Nurse/assistance call buttons and emergency response pendants thus tend to be another reactive form of assistance. They may help in bringing aid to a resident who has fallen, but do very little to prevent falls from happening in the first place

### SUMMARY

In one aspect, a system for monitoring of at least one person, includes a local system in the vicinity of the person. The local system includes a plurality of sensor systems, each of the plurality of sensor systems being adapted to monitor changes in state of at least one monitored system caused by activity or lack of activity of the person, and a local communication device in communicative connection with each of the plurality of sensor systems to receive data from each of the plurality of sensor systems. Each of the plurality of sensor systems is adapted to send a periodic signal to the local communication device to provide an indication of the operability thereof. The local system is adapted to provide an alert if one of the plurality of sensor systems fails to transmit the periodic signal to the communication device.

The system may further include a remote system in communication with the local communication device. The remote system may, for example, include a processing system to process data from the plurality of sensor systems based upon predetermined rules. The remote system may also be adapted to provide an alert if communication with the local communication device fails.

In a number of embodiments, a determination of signal strength of the periodic signal is made to determine if the local communication device is receiving adequate signal. At least one of the plurality of sensor systems may, for example, be a presence sensor system adapted to determine at least the presence or the absence of a person on an item. In a number of embodiments, at least one of the plurality of sensor systems is a presence sensor system adapted to determine at least the presence or the absence of a person on a bed or a wheelchair.

The local system may, for example, be placed in operative connection with an assisted living facility, and may, for example, used to monitor a plurality of persons residents in the assisted living facility. The plurality of sensor systems may include a plurality of presence sensors adapted to determine at least the presence or the absence of one of the plurality of persons on a bed and/or on a wheelchair of the one of the plurality of persons. The plurality of presence sensors may, for example, be used to provide an indication of a fall or a potential fall of at least one of the plurality of persons.

In another aspect, a system for monitoring of at least one person, includes a local system in the vicinity of the person. The local system includes a plurality of sensor systems, each of the plurality of sensor systems being adapted to monitor changes in state of at least one monitored system caused by activity or lack of activity of the person, and a local communication device in communicative connection with each of the plurality of sensor systems to receive data from each of the plurality of sensor systems. The system further includes a remote system in communication with the local communication device. The remote system includes a processing system to process data from the plurality of sensor systems based upon predetermined rules. The remote system is adapted to provide an alert to a caregiver via communication between the remote system and the local communication device of the local system. The local system is adapted to provide a local alert to at least one caregiver in at least one predetermined circumstance without the local system receiving the local alert from the remote system.

The system may further include at least one pager device to be worn by the at least one caregiver. The at least one pager device may, for example, be in wireless communicative connection with the local communication device to receive the alert or the local alert from the local communication device. The local system may, for example, be adapted to determine the location of one of the plurality of sensors systems giving rise to the alert or the local alert.

In a number of embodiments, the at least one pager device includes a communication interface to receive signals from and transmit signals to the local communication device, the at least one pager device being adapted to transmit a response initiated by the at least one caregiver to the local communication device to confirm receipt of the alert or the local alert. Transmittal of the response may, for example, require initiation of at least two independent steps by the at least one caregiver. Transmittal of the response may, for example, require activation of at least two separate buttons by the at least one caregiver (for example, at the same time or in a predetermined manner/sequence).

In another aspect, system for monitoring of at least one person includes a local system in the vicinity of the person. The local system includes a plurality of sensor systems, each of the plurality of sensor systems being adapted to monitor changes in state of at least one monitored system caused by activity or lack of activity of the person, and a local communication device in communicative connection with each of the plurality of sensor systems to receive data from each of the plurality of sensor systems. The system further includes at least one pager device to be associated with at least one caregiver. The at least one pager device is in wireless communicative connection with the local communication device to receive an alert from the local communication device. The at least one pager device includes a communication interface to receive signals from and transmit signals to the local communication device. The at least one pager device is adapted to transmit a response initiated by the at least one caregiver to the local communication device to confirm receipt of the alert.

As described above, transmittal of the response may, for example, require initiation of at least two independent steps by the at least one caregiver. In a number of embodiments, transmittal of the response requires activation of at least two separate buttons by the at least one caregiver.

The local communication device may, for example, be adapted to periodically resend the alert until the response is received by the local communication device. In a number of embodiments, the system includes a plurality of pager devices, each of the plurality of pager devices being associated with one of a plurality of caregivers. The system may, for example, be adapted to send the alert to each of the plurality of caregivers. In a number of embodiments, the system is adapted to send the alert to one of the plurality of caregivers determined to be closest to one of the plurality of sensor systems determined to have given rise to the alert.

In another aspect, a system for monitoring each of a plurality of persons in an assisted living facility includes a local system in the assisted living facility. The local system includes a plurality of sensor systems, each of the plurality of sensor systems being adapted to monitor changes in state of at least one monitored system caused by activity or lack of activity of the person, the plurality of sensor systems including a plurality of presence sensors adapted to determine at least the presence or the absence of each one of the plurality of persons on a bed thereof or on a wheelchair thereof. The local system further includes a local communication device in communicative connection with each of the plurality of sensor systems to receive data from each of the plurality of sensor systems. The system further includes a remote system situated remote from the assisted living facility and in communication with the local communication device. The remote system includes a processing system to process data from the plurality of sensor systems based upon predetermined rules. The remote system is adapted to provide an alert to at least one caregiver present at the assisted living facility via communication between the remote system and the local communication device of the local system. The remote system is also adapted to determine at least one metric of bed use to determine if there is a potential change in condition of each of the plurality of persons.

In a number of embodiments, the at least one metric of bed use is determined on the basis of a predetermined period time and is time out of bed, time in bed, number of times out of bed, duration of times out of bed, total outs of sleep, time of going to bed, or time of arising from bed.

In another aspect, a system for monitoring each of a plurality of persons in an assisted living facility includes a local system in the assisted living facility. The local system includes a plurality of sensor systems, each of the plurality of sensor systems being adapted to monitor changes in state of at least one monitored system caused by activity or lack of activity of the person. The plurality of sensor systems includes a plurality of presence sensors adapted to determine at least the presence or the absence of each one of the plurality of persons on a bed thereof or on a wheelchair thereof. The local system further includes a local communication device in communicative connection with each of the plurality of sensor systems to receive data from each of the plurality of sensor systems. The system further includes a remote system situated remote from the assisted living facility and in communication with the local communication device. The remote system includes a processing system to process data from the plurality of sensor systems based upon predetermined rules. The remote system is adapted to provide an alert to at least one caregiver present at the assisted living facility via communication between the remote system and the local communication device of the local system. At least the remote system is adapted provide an alert related to a fall risk to the at least one caregiver upon determining absence of one of the plurality of persons from a bed or from a wheelchair.

In a further aspect, the system for monitoring each of a plurality of persons in an assisted living facility includes a local system in the assisted living facility. The local system includes a plurality of sensor systems, each of the plurality of sensor systems being adapted to monitor changes in state of at least one monitored system caused by activity or lack of activity of the person. The plurality of sensor systems includes a plurality of presence sensors adapted to determine at least the presence or the absence of each one of the plurality of persons on a bed thereof or on a wheelchair thereof. The local system further includes a local communication device in communicative connection with each of the plurality of sensor systems to receive data from each of the plurality of sensor systems. The system further includes a remote system in communication with the local communication device. The remote system includes a processing system to process data from the plurality of sensor systems based upon predetermined rules. The remote system is adapted to provide at least one of (i) a fall alert to at least one caregiver present at the assisted living facility via communication between the remote system and the local communication device of the local system upon determining absence of one of the plurality of persons from the bed thereof or from the wheelchair thereof and (ii) a condition alert to the at least one caregiver present at the assisted living facility via communication between the remote system and the local communication device of the local system related to at least one metric of bed use determined by the remote system and related to a potential change in condition of in each of the plurality of persons. The remote system provides for adjusting sensitivity of at least one parameter for determining if the fall alert is required or if the condition alert is required.

The remote system may, for example, provide for a hierarchy of adjusting sensitivity of the at least one parameter. The hierarchy may, for example, range from a facility-wide adjustment to a per-person adjustment.

In another aspect, a system for monitoring a plurality of persons in an assisted living facility, includes a local system in the assisted living facility. The local system includes a plurality of sensor systems. Each of the plurality of sensor systems is adapted to monitor changes in state of at least one monitored system caused by activity or lack of activity of at least one of the plurality of persons. The plurality of sensor systems include a plurality of presence sensors adapted to determine at least the presence or the absence of each one of the plurality of persons on a bed thereof or on a wheelchair thereof. The local system further includes a local communication device in communicative connection with each of the plurality of sensor systems to receive data from each of the plurality of sensor systems. The system further includes a remote system in communication with the local communication device. The remote system includes a processing system to process data from the plurality of sensor systems based upon predetermined rules. The remote system is adapted to provide an alert to at least one caregiver. The alert includes at least one of (i) a fall alert to at least one caregiver present at the assisted living facility via communication between the remote system and the local communication device of the local system upon determining absence of one of the plurality of persons from the bed thereof or from the wheelchair thereof; and (ii) a condition alert to the at least one caregiver present at the assisted living facility via communication between the remote system and the local communication device of the local system related to at least one metric of bed use determined by the remote system and related to a potential change in condition of one of the plurality of persons. In a number of embodiments, the remote system is adapted to provide each of the fall alert and the condition alert. The local system may be adapted to provide a local alert to at least one caregiver in at least one predetermined circumstance without the local system receiving the local alert from the remote system.

In a number of embodiments, the remote system provides for adjustment of the sensitivity of at least one parameter for determining if the fall alert is required or if the condition alert is required. The remote system may, for example, provides for a hierarchy of adjusting sensitivity of the at least one parameter. The hierarchy may, for example, range from a facility-wide adjustment to a per-person adjustment.

Each of the plurality of sensor systems may, for example, be adapted to send a periodic signal to the local communication device to provide an indication of the operability thereof. The local system may, for example, be adapted to provide an alert if one of the plurality of sensor systems fails to transmit the periodic signal to the communication device. In a number of embodiments, a determination of signal strength of the periodic signal is made to determine if the local communication device is receiving adequate signal.

In a number of embodiments, the system further includes at least one pager device to be worn by the at least one caregiver. The at least one pager device may, for example, be in wireless communicative connection with the local communication device to receive the alert. The wireless communicative connection may, for example, be via radio signals such as short range radio signals. The system may, for example, be adapted to determine the location of one of the plurality of sensors systems giving rise to the alert. In a number of embodiments, the at least one pager device includes a communication interface to receive signals from and transmit signals to the local communication device. The at least one pager device may, for example, be adapted to transmit a response initiated by the at least one caregiver to the local communication device to confirm receipt of the alert or the local alert. Transmittal of the response may, for example, require initiation of at least two independent steps by the at least one caregiver. In a number of embodiment, the system is adapted to determine the location of the at least one pager device. The determination of the location of the at least one pager device may result, at least in part, from communication between the at least one pager device and the plurality of sensor systems. The system may, for example, be adapted to determine a response to the alert by determining the position of the at least one pager device to be in the vicinity of the location of the one of the plurality of sensor systems giving rise to the alert.

In a number of embodiments, the system includes a plurality of pager devices, each of the plurality of pager devices being associated with one of a plurality of caregivers. The system may, for example, be adapted to send the alert to each of the plurality of caregivers. In a number of embodiments, the system is adapted to determine the location of each of the plurality of pager devices. The system may, for example, be adapted to determine the location of each of the plurality of pager devices, at least in part, by communication between the plurality of pager devices and the plurality of sensor systems. In a number of embodiments, the system is adapted to send the alert to one of the plurality of caregivers determined by the system via at least one predetermined rule. For example, the system may be adapted to send the alert to the one of the plurality of caregivers determined to be closest to the one of the plurality of sensors giving rise to the alert (as determined via determination of the location of one of the plurality of sensors).

Each of the plurality of pager devices may, for example, include a communication interface to receive signals from and transmit signals to the local communication device. Each of the plurality of pager devices may, for example, be adapted to transmit a response initiated by the at least one caregiver to the local communication device to confirm receipt of the alert or the local alert. In a number of embodiments, the system is adapted to determine a response to the alert by determining the position of at least one of the plurality of pager devices to be in the vicinity of the location of the one of the plurality of sensor systems giving rise to the alert.

In a number of embodiments, the at least one metric of bed use is determined on the basis of predetermined consecutive time periods, wherein, for each predetermined consecutive time period, bed presence is monitored for a predetermined monitoring period of time. The predetermined consecutive time periods may, for example, be 24-hour days and the predetermined monitoring period of time may, for example, be 24 hours or less and occurs over the same time period in each consecutive day. A plurality of metric including at least out-of-bed events, out-of-bed duration, and time in bed are monitored during each predetermined monitoring period. In a number of embodiments, the plurality of metrics further includes motion or activity while in bed.

In another aspect, a system for monitoring a plurality of persons in an assisted living facility includes a local system in the assisted living facility. The local system includes a plurality of sensor systems. Each of the plurality of sensor systems is adapted to monitor changes in state of at least one monitored system caused by activity or lack of activity of at least one of the plurality of persons. The plurality of sensor systems includes a plurality of presence sensors adapted to determine at least the presence or the absence of each one of the plurality of persons on a bed thereof or on a wheelchair thereof. The local system further includes a local communication device in communicative connection with each of the plurality of sensor systems to receive data from each of the plurality of sensor systems. The system further includes a remote system situated remote from the assisted living facility and in communication with the local communication device. The remote system includes a processing system to process data from the plurality of sensor systems based upon predetermined rules. The remote system is adapted to provide an alert to at least one caregiver present at the assisted living facility via communication between the remote system and the local communication device of the local system. The remote system is adapted to determine at least one metric of bed use to determine if there is a potential change in condition of each of the plurality of persons.

The at least one metric of bed use may, for example, be determined on the basis of predetermined consecutive time periods, wherein, for each predetermined consecutive time period, presence in bed is monitored for a predetermined monitoring period of time. In a number of embodiments, the predetermined consecutive time periods are 24-hour days and the predetermined monitoring period of time is 24 hours or less and occurs over the same time period in each consecutive day.

A plurality of metric including at least out-of-bed events, out-of-bed duration, and time in bed may, for example, be monitored during each predetermined monitoring period. The metrics of bed may further include a measurement of motion while in bed.

The predetermined rules may, for example, include at least one rule to determine whether one of 24-hour days is to be included in determining the baseline. The predetermined rules may, for example, include rules to determine whether out of bed events are counted during the predetermined monitoring period of time.

In another aspect, a system for monitoring a person includes a presence sensor system adapted to determine at least the presence or the absence of the person on a bed thereof and a processing system to process data from the presence sensor system based upon predetermined rules and metrics of bed use to determine if there is a potential change in condition of the person. Each of the metrics of bed use may be determined on the basis of predetermined consecutive time periods, wherein, for each predetermined consecutive time period, presence in bed is monitored for a predetermined monitoring period of time. The metrics of bed use may include at least out-of-bed events, out-of-bed duration, and time in bed. In a number of embodiments, the processing system is adapted to execute an algorithm to determine a baseline for at least one of the metrics of bed use over at least a predetermined number of the consecutive time periods and to determine at least one of whether the at least one of the metrics of bed use varies from the baseline by a first predetermined threshold or whether the baseline varies by a second predetermined threshold. In a number of embodiments, the metrics of bed use further include a measurement of motion while in bed.

The predetermined consecutive time periods may, for example, be 24-hour days and the predetermined monitoring period of time may, for example, be 24 hours or less and occur over the same time period in each consecutive day. In a number of embodiments, the algorithm includes at least one rule to determine whether one of 24-hour days is to be included in determining the baseline. The algorithm may, for example, include at least one rule to determine whether out of bed events are counted during the predetermined monitoring period of time.

In a further aspect, a system for monitoring a plurality of persons in an assisted living facility, includes a local system in the assisted living facility which includes a plurality of sensor systems. Each of the plurality of sensor systems is adapted to monitor changes in state of at least one monitored system caused by activity or lack of activity of at least one of the plurality of persons. The plurality of sensor systems includes a plurality of presence sensors adapted to determine at least the presence or the absence of each one of the plurality of persons on a bed thereof or on a wheelchair thereof. The local system further includes at least one local communication device in communicative connection with each of the plurality of sensor systems to receive data from each of the plurality of sensor systems. The local communication device is adapted to provide an alert to at least one the plurality of caregivers. The system further includes a plurality of pager devices. Each of the plurality of pager devices is associated with one of a plurality of caregivers. Each of the plurality of pager devices includes a communication system adapted to receive the alert and to communicate with the local system to effect at least one of a notification by the one of the plurality of caregivers of receipt of the alert or determination of the location of each of the plurality of pager devices.

In a number of embodiments, the system further includes a remote system situated remote from the assisted living facility and in communication with the local communication device. The remote system may, for example, include a processing system to process data from the plurality of sensor systems based upon predetermined rules. The remote system may, for example, be adapted to provide the alert to at least one caregiver present at the assisted living facility via communication between the remote system and the local communication device of the local system.

In a number of embodiments, the system is adapted to determine the location of each of the plurality of pager devices. Location of each of the plurality of pager devices may, for example, be determined, at least in part, by communication between the plurality of pager devices and the plurality of sensor systems (for example, via radio signals such as short range radio signals).

In still a further aspect, an audible alarm sensor system to monitor a primary sensor system including an audible alarm and determine if the audible alarm is activated includes a microphone, a processor in communicative connection with the microphone, and a communication interface in communicative connection with the processor. The communication interface is adapted to communicate an indication that the audible alarm of the primary sensor system is in an active state. The processor is adapted to execute a calibration process so that the audible alarm sensor system can determine the active state from an inactive state of the audible alarm. In a number of embodiments, no physical connection is required between the audible alarm sensor system and the primary sensor system. In a number of embodiments, tone frequency of the audible alarm, amplitude of the audible alarm and pulse characteristics of the audible alarm need not be known in advance of the calibration process and need not comply with a known signaling standard. In a number of embodiments, the audible alarm system sensor is adapted to detect the audible alarm wherein a signaling characteristic of the audible alarm changes over time during activation of the audible alarm. The audible alarm need not, for example, be a pure tone.

In a number of embodiments, audio signals from the microphone are grouped into frames and digitized. Both audio signal frequency and audio signal energy may, for example, be measured. A histogram of power spectral density versus frequency may, for example, be computed by the processor. In a number of embodiments, a predetermined percentage of the power spectral density in predetermined frequencies of interest must be present for a first number of frames to determine that the audible alarm is in an activated state. In a number of embodiments, a predetermined percentage of the power spectral density in predetermined frequencies of interest must be absent for a second number of frames to determine that the audible alarm is in a deactivated state. The predetermined frequencies may, for example, be determined during the calibration process. In a number of embodiments, the audible alarm sensor system monitors the audible alarm, which is activated or in an activated/alarming state, during the calibration process and determines frequency bins that contain the highest power spectral density.

The present devices, systems and methods, along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a schematic representation of an embodiment of a system for collecting data from a plurality of sensing devices and providing information/alerts to one or more caregivers.

FIG. 1B illustrates a schematic representation of the system of FIG. 1A used in connection with an assisted living facility, a skilled care facility, a nursing home facility, a memory care facility and the like.

FIG. 1C illustrates an another schematic representation of the system of FIG. 1A.

FIG. 2A illustrates a schematic diagram of a sensor system or presence sensor system to detect presence of a resident in a bed, wheelchair and the like.

FIG. 2B illustrates a top view of the sensor system of FIG. 2A as used in connection with a bed.

FIG. 2C illustrates a side cutaway view of a portion of a sensor of the sensor system of FIG. 2A.

FIGS. 3A through 3M each illustrate monitoring time lines in which a monitoring period and in and out of bed events are set forth, wherein a key for the monitoring window and the in-bed state for each of FIGS. 3A through 3M is set forth in FIG. 3A.

FIG. 4A illustrates a schematic diagram of another sensor system to detect the presence of a resident on, for example, a bed, a wheelchair and the like.

FIG. 4B illustrates the sensor system of FIG. 4A including one of more sensor volumes enclosed by one or more resilient extending members such as tubes, pads etc. in operative connection with a bed.

FIG. 4C illustrates an enlarged side view of one of the extending members of FIG. 4B in fluid connection with a pressure transducer via an intermediate conduit and a cross-sectional view of one of the extending members.

FIG. 4D illustrates a side view of a sensor volume of a sensor system of FIG. 4A positioned between a mattress and a box spring of a bed.

FIG. 4E illustrates an embodiment of a circuit diagram for an embodiment of a sensor system hereof.

FIG. 4F illustrates a schematic diagram of another sensor system to detect the presence of a resident on, for example, a bed, a wheelchair and the like.

FIG. 5 illustrates schematically an embodiment of a pager system for use in connection with one or more caregivers.

FIG. 6A illustrates schematically an embodiment of an audible alarm sensor system for use in connection with a primary sensor system which includes an audible alarm.

FIG. 6B illustrates a flow chart illustrating an embodiment of an operational methodology for the audible alarm sensor system of FIG. 6A.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the content clearly dictates otherwise. Thus, for example, reference to “a sensor” includes a plurality of such sensors and equivalents thereof known to those skilled in the art, and so forth, and reference to “the sensor” is a reference to one or more such sensors and equivalents thereof known to those skilled in the art, and so forth. Recitation of ranges of values herein are merely intended to serve as a shorthand method of referring individually to each separate value falling within the range. Unless otherwise indicated herein, and each separate value, as well as intermediate ranges, are incorporated into the specification as if individually recited herein. All methods described herein can be performed in any suitable order unless otherwise indicated herein or otherwise clearly contraindicated by the text.

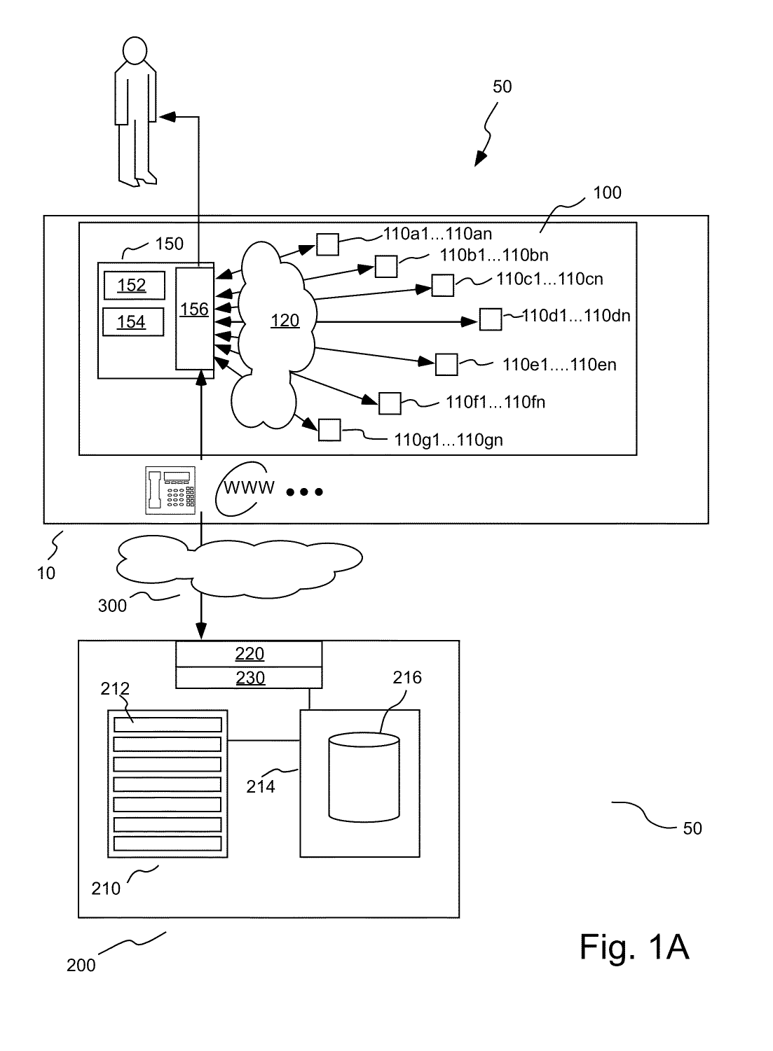

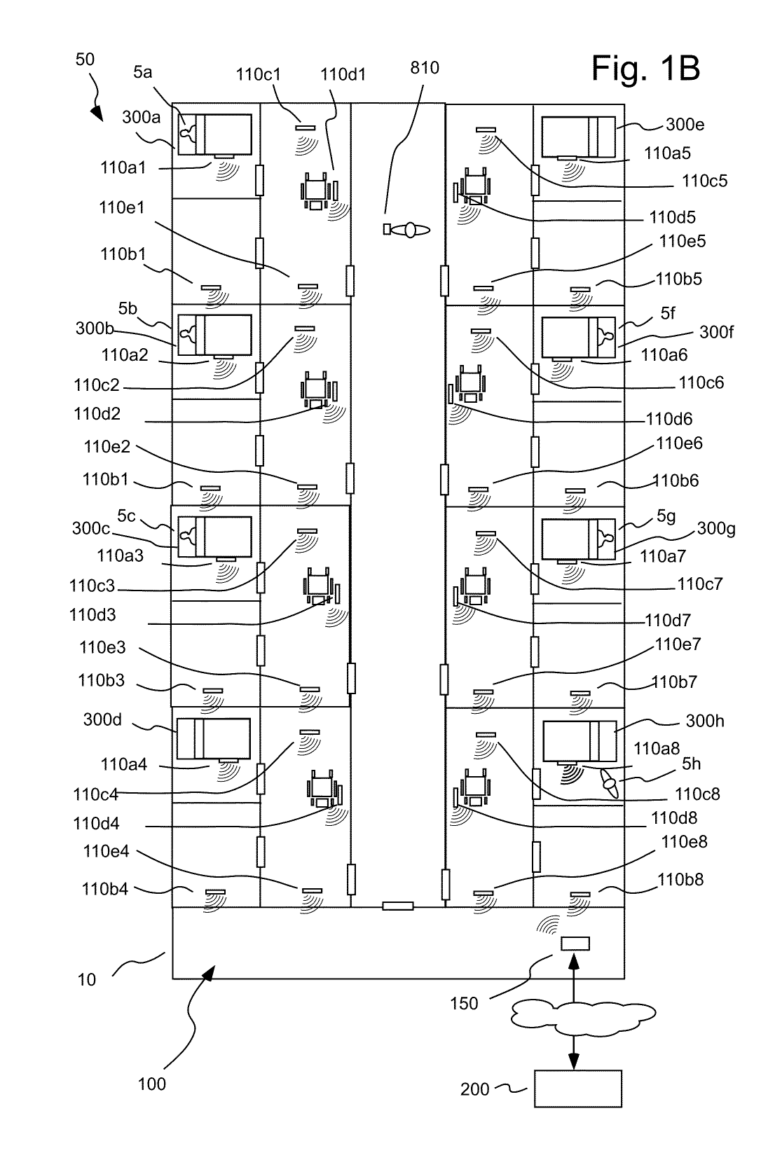

In a number of representative embodiments hereof, a monitoring system 50 monitors at least the sleeping behavior of a person 5a (and typically a plurality of residents 5a . . . 5n; see, for example, FIG. 1B), who may, for example, be a resident in an assisted living residence or facility 10. Other, basic day-to-day activities or lack of activity of residents 5a . . . 5n may also be monitored (such as television usage, eating habits, compliance with medicine dosages, water use, wheelchair use, appliance use etc.). Examples of sensors for use in monitoring activities are described, for example, in U.S. Patent Application Publication Nos. 2012/0056746, 2013/0085688, 2013/0081479, and 2013/0340500, the disclosures of which are incorporated herein by reference.

System or monitoring system 50 provides real time monitoring of sleep behavior and/or bed presence and, in some embodiments, other parameters indicative of the state of one or more residents 5a . . . 5n. System 50 also provides timely alerts designed, for example, to help prevent or react quickly to an acute episode such as a fall. System 50 may be used in conjunction with, for example, a personal emergency response system (PERS) or an assistance call device. System 50 may also be operated as a standalone system, to provide monitoring to assist a caregiver staff.

While the monitoring of residents 5a . . . 5n via a local system 100 (see FIGS. 1A through 1C) is real-time, the transmission of the collected data to a remote system 200, and ultimately to a caregiver (for example, a professional caregiver in an assisted living facility), may be performed in a real-time and/or in a periodic, discontinuous or batch manner. For example, data or information of an activity (for example, sleep activity) of person 5a may be transmitted by local system 100 to remote system 200 in real time for processing and/or analysis, while data or information of another activity for a given period (for example, a prior period of minutes or hours) may be transmitted by local system 100 to remote system 200 periodically for processing and/or analysis by remote system 200. Remote system 200 can receive data from many local systems 100 regarding many different monitored persons 5a . . . 5n in many different residences or facilities 10. Local system 100 may include a processing system including one or more processors programmed or adapted to determine if one or more defined states is/are in existence (for example, based upon data from monitored devices and/or systems or from information or lack of information from remote system 200) and to effect one or more actions as a result thereof.

In a number of representative embodiments (as illustrated, for example, in FIGS. 1A through 1C), local system 100 of monitoring system 50 may include a plurality of bed sensor systems 110a1 . . . 110an, each of which is in operative connection with a bed of one of a plurality of residents 5a . . . 5n (see FIG. 1B). As described above, other sensor systems 110b1 . . . 110bn, 110c1 . . . 110cn, 110d1 . . . 110dn, 110e1 . . . 110en, 110f . . . 110fn, 110g . . . 110gn etc. may be provided for sensing activities or lack of activities of residents 5a . . . 5n, respectively, in the living quarters thereof and/or in common areas. The sensor systems communicate using a local area network such as a wireless local area network (wireless LAN or WLAN) with a local data communication device or hub 150. Sensor systems 110b1 . . . 110bn, 110c1 . . . 110cn, 110d1 . . . 110dn, 110e1 . . . 110en, 110f . . . 110fn, 110g . . . 110gn etc. may, for example, be operatively connected to or associated with furniture, wheelchairs, utilities (for example, water utilities), equipment, devices, systems or appliances as described in U.S. Patent Application Publication Nos. 2012/0056746, 2013/0085688, 2013/0081479, and 2013/0340500.

Data from sensor systems 110a1 . . . 110an, 110b1 . . . 110bn, 110c1 . . . 110cn, 110d1 . . . 110dn, 110e1 . . . 110en, 110f . . . 110fn, 110g . . . 110gn etc. of local system 100 (which may or may not be processed at least to some extent in local system 100) may be communicated, transmitted, or uploaded to remote system 200 via, for example, local data communication device 150. Remote system 200 may, for example, include a central processing system or a distributed processing system that may, for example, include one or more computers, servers or server systems 210. Computer(s), server(s) or server system(s) 210 may, for example, include one or more processors or processor systems 212 which are in communicative connection with one or more memory or storage systems 214 as known in the computer arts. Memory system(s) 214 may include one or more databases 216 stored therein. Local system 100 may communicate with a communication system or systems 220 of remote system 200 (for example, via local data communication device 150) through one or more wired and/or wireless communication channels 300 (for example, landline telephones, wireless telephones, a broadband internet connection and/or other communication channel(s)). Software stored in memory system(s) 214 or in one or more other memory system in communicative connection with processor(s) 210 may be used to process or analyze data from local system 100 and, for example, assist a caregiver or caregivers with a long-term care plans, alerts, use of additional sensor systems etc.

In a number of embodiments, communication system 220 may, for example, be in communicative connection with a gateway processor 230 of remote system 200. Gateway processor 230 may, for example, receive data from local data communication device 150 of local system 100, process that data (which may, for example, be received in binary file format) into a format readable by software executed by processor 210, and insert the processed data into database 216. In a number of embodiments, gateway processor 230 is adapted to receive data of a number of different types (for example, data regarding states from sensor systems 110a1 . . . 110an, 110b1 . . . 110bn, 110c1 . . . 110cn, 110d1 . . . 110dn, 110e1 . . . 110en, 110f1 . . . 110fn, 110g1 . . . 110gn etc.), provide initial processing of such data and route such data into a designated system such as into database 216.

Processing system(s) or server system(s) 210 of remote system 200 receive data from local system 100 and, for example, use/processes the data to implement a care plan as described herein. Server system(s) 210 may, for example, apply predetermined rules and/or logic defining alert thresholds, alert methods, appointed caregivers, associated reports for trending etc. in implementing a care plan. Remote alerts can, for example, be activated in the case of predetermined events (or a series or groups of events) or at predetermined levels (as determined by monitoring system 50 on the basis of established rules and/or protocols) so that caregivers can, for example, respond in a proactive manner to changes in behavior and/or status of residents 5a . . . 5n. The alerts can, for example, be dispatched or made available to one or more caregivers (or others) via displays or interfaces in any number of ways through communications channel(s) 300 including, but not limited to interactive voice response or IVR, short message service or SMS, internet web pages, email, other internet communications (for example, instant messaging or IM), paging applications, and/or smart phone/client applications. Monitoring systems 50 hereof may provide more proactive/timely alerts, while significantly reducing cost and complexity as compared to other systems.

In a number of embodiments, caregivers may also transmit inquiries to remote system 200 via one or more communication channels 300 as described above to, for example, inquire of the current “status” of one or more of residents 5a . . . n or prepare various reports. Such an inquiry may, for example, result in a polling of one or more sensor systems 110a1 . . . 110an, 110b1 . . . 110bn, 110c1 . . . 110cn, 110d1 . . . 110dn, 110e1 . . . 110en, 110f1 . . . 110fn, 110g1 . . . 110gn etc. by local data communication device 150 for current or most recent data, which is the uploaded to remote system 200. Further, system 50 can transfer information to third parties (for example, physicians etc.) as part of an overall care plan. For example, a physician (or other authorized third party) portal can be provided as a module of communication system 220 of remote system 200.

In assisted living facilities, monitors such as bed alarms are not typically networked together and, as such, do not have or provide the capability to monitor themselves. Some monitors may, for example, be able to trigger an audible or visual alert which passively highlights that they are not working properly. Because the sensor systems hereof are networked, system 50 provides the capability to perform monitoring of the operational state of the sensor systems and/or other components thereof.

In a number of embodiments, sensor systems 110a1 . . . 110an, 110b1 . . . 110bn, 110c1 . . . 110cn, 110d1 . . . 110dn, 110e1 . . . 110en, 110f1 . . . 110fn, 110g1 . . . 110gn each “ping” the communication device or hub 150 periodically (for example, every 2 seconds). If remote system 200 fails to see such a signal, which may be referred to as a “heartbeat”, from one of the sensor systems, system 50 notifies an appropriate person or persons that there may be a problem with the sensor system. Communication device 150 may also send data regularly to remote system 200 and, if such uploads of data are not received within a reasonable period of time, system 50 may automatically notify the appropriate person or persons that there is a problem communicating with communication device 150. Such lack of communication may, for example, be the result of communication device 150 being unplugged, being disconnected from a communication system such as the internet, the result of a software and/or hardware problem with communication device 150 or the result of other similar issues. Furthermore, signals to and/or from networked components of system 200 may also be monitored for signal strength. Signal strength monitoring allows system 50 to detect, for example, if communication device 150 is receiving adequate signals from sensor systems 110a1 . . . 110an, 110b1 . . . 110bn, 110c1 . . . 110cn, 110d1 . . . 110dn, 110e1 . . . 110en, 110f1 . . . 110fn, 110g1 . . . 110gn on a regular basis and helps with remote troubleshooting if a communication link is interrupted.

In a number of embodiments hereof bed usage or bed presence is used to, for example, prevent or quickly detect a fall incident. Monitoring of bed usage can, for example, be accomplished in various manners including, for example, use of a pressure sensitive member (for example, a pad, tube etc.) placed on or under the mattress of the bed to indicate the presence of a person in bed, or the use of a pressure sensor located on or under a leg of the bed and designed to monitor change in weight, thereby indicating the presence of a person in bed. Other sensor systems for sensing the presence of a person in a bed may, for example, include piezo resistive films, thick film strain sensors, infrared sensors, accelerometers, acoustic sensors, carbon dioxide sensors and/or body temperature sensors. In a number of embodiments, one or more sensor systems may provide for detection of the presence and/or movement of person(s)/resident(s) 5a . . . 5n on a bed or another item (for example, a wheelchair or an item furniture upon which resident 5a . . . 5n would rest such as a chair, a sofa etc.). Such sensors are referred to herein generally as presence sensor systems.

Sensor systems hereof may, for example, stream analog-based data to a remote or central server or software device which then converts the streamed data to meaningful information. However, analog data is by its nature memory intensive and network bandwidth intensive, thereby increasing the cost of transmitting the data, slowing the transmission of the data, and limiting/consuming network bandwidth.

In several embodiments of the methods and systems hereof, one or more of sensors 110a1 . . . 110an, 110b1 . . . 110bn, 110c1 . . . 110cn, 110d1 . . . 110dn, 110e1 . . . 110en, 110f1 . . . 110fn, 110g1 . . . 110gn etc. as described above monitor a variable or a set of variables or parameters indicating state(s), changes in state and/or a lack of a change in state (for example, indicating operational use or disuse). Sensors may, for example 110a1 . . . 110an, 110b1 . . . 110bn, 110c1 . . . 110cn, 110d1 . . . 110dn, 110e1 . . . 110en, 110f1 . . . 110fn, 110g1 . . . 110gn etc. collect analog data which are recorded (or convert into) event or state-based data, which may be represented as discrete values. Data of states and changes of states (as defined in monitoring system 50) of a monitored device or system may, for example, be generated to provide a state history in which, for example, defined states and durations of such defined states over time are set forth for a period of time. Rather than transmitting a stream of analog operational or status data, state-based data or values which, for example, correspond to the state or state history of a monitored device or system (for example, time of use/state change, duration of state, level of use etc.) for a period of time may be transmitted to communication system 220 of remote system 200. In that regard, the data may be transmitted by communication system 152 of local data communication device 150 via one or more of communication channels 300 (for example, via telephone, internet etc.) to communication system 220 of remote system 200. The data may, for example, be transferred continuously or periodically. Different data or values may, for example, be transmitted with different time intervals or frequencies depending upon the nature of the underlying event(s) or values as set forth in predetermined rules.

As described above, some processing of data may occur in a processing system of local system 100. Such processing may, for example, occur in a processor or processors of one or more of sensors 110a1 . . . 110an, 110b1 . . . 110bn, 110c1 . . . 110cn, 110d1 . . . 110dn, 110e1 . . . 110en, 110f1 . . . 110fn, 110g1 . . . 110gn etc. (for example, in processor 114a1 of sensor system 110a1), in a processor or processors 154 of local data communication device 150 and/or in one or more other processors of local system 100 before transfer of data to the remote system 200. In a number of embodiments, local data communication device 150 serves as a repository for all information coming from sensors 110a1 . . . 110an, 110b1 . . . 110bn, 110c1 . . . 110cn, 110d1 . . . 110dn, 110e1 . . . 110en, 110f1 . . . 110fn, 110g1 . . . 110gn etc. Additional processing in processor 154, when effected, may, for example, include: comparing of values with prior average values, evaluation of combinatorial events from more than one sensor or sensor system to infer or determine situations or events not necessarily inferable or determinable from a single sensor or sensor system, and the transmission of data/information to remote system 200. In that regard, a plurality of sensors working in concert as part of a larger network monitoring system and designed to upload data on, for example, a predetermined period leave open the possibility that a meaningful event can occur in space 10 that does not generate an alert or alerts from remote system 200 until the data is uploaded to remote system 200. An excessive delay can reduce the effectiveness of monitoring system 50 and potentially result in negative clinical benefits to person 5 if it results in delay of an appropriate reaction to a clinical need or problem. One skilled in the art can readily determine a suitable period for uploads for a particular environment. Continuous streaming of analog data may also be used if sufficient network bandwidth and memory is available.

In a number of embodiments, transmission of data to remote system 200 for at least a number of sensor systems occurs on a regular, periodic basis and/or on an unscheduled or exception basis. In that regard, exceptions or triggering events defined by predetermined states or state changes, groups of states or state changes, events, thresholds, or business logic, are established which, when determined to be in existence (using defined rules), trigger an automatic upload of data to remote system 200 regardless of predetermined upload cycles. Such exceptions or triggering events result in more timely and effective monitoring of person 5. Software or logic to determine such an exception or a triggering event can, for example, be resident on a sensor system, on local data communication device 150 and/or on a separate processor system of local system 10. Thus, an exception occurs when a condition is determined to exists (via processing/analysis of sensor data in local system 100) which requires expedited or immediate attention from remote system 200.

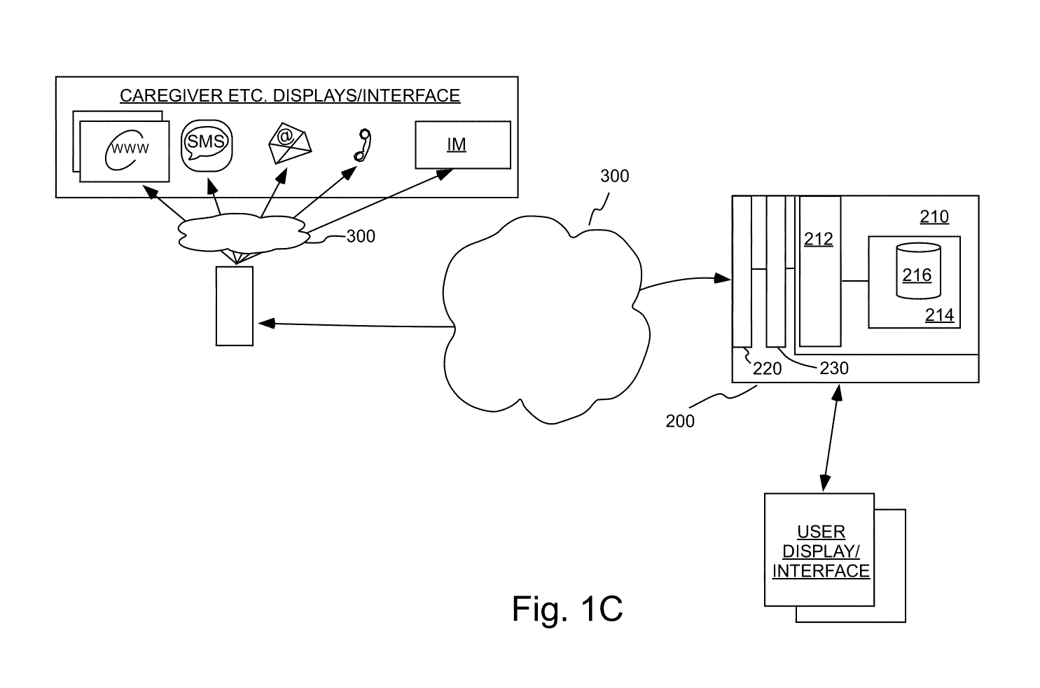

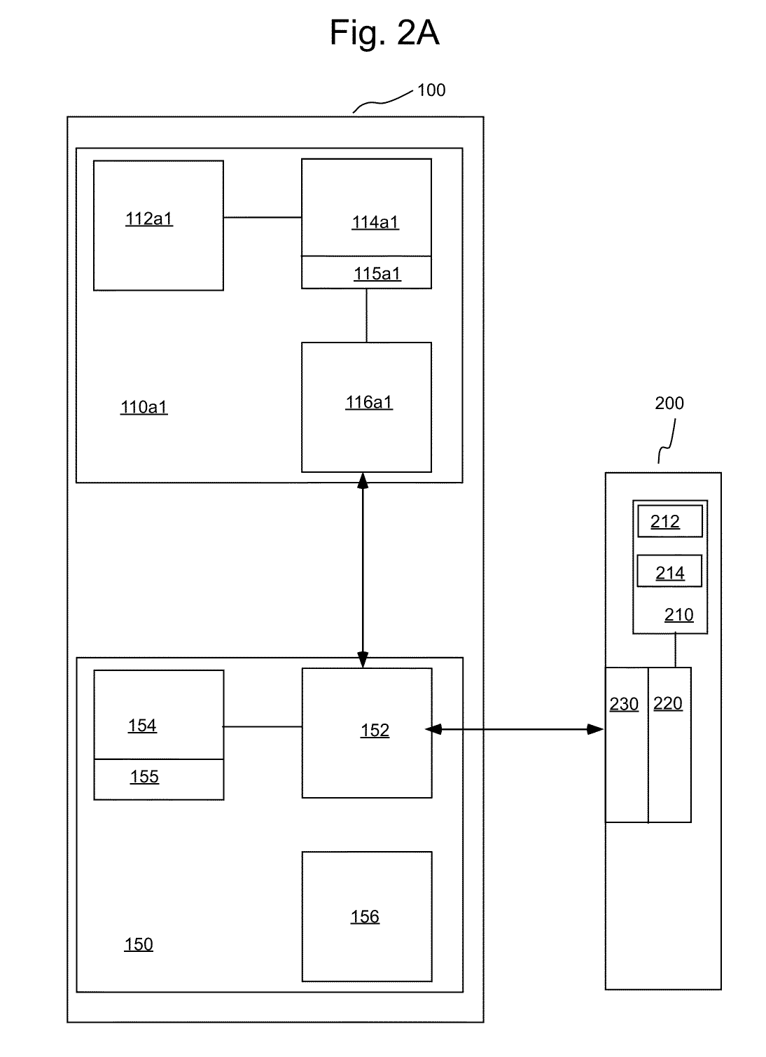

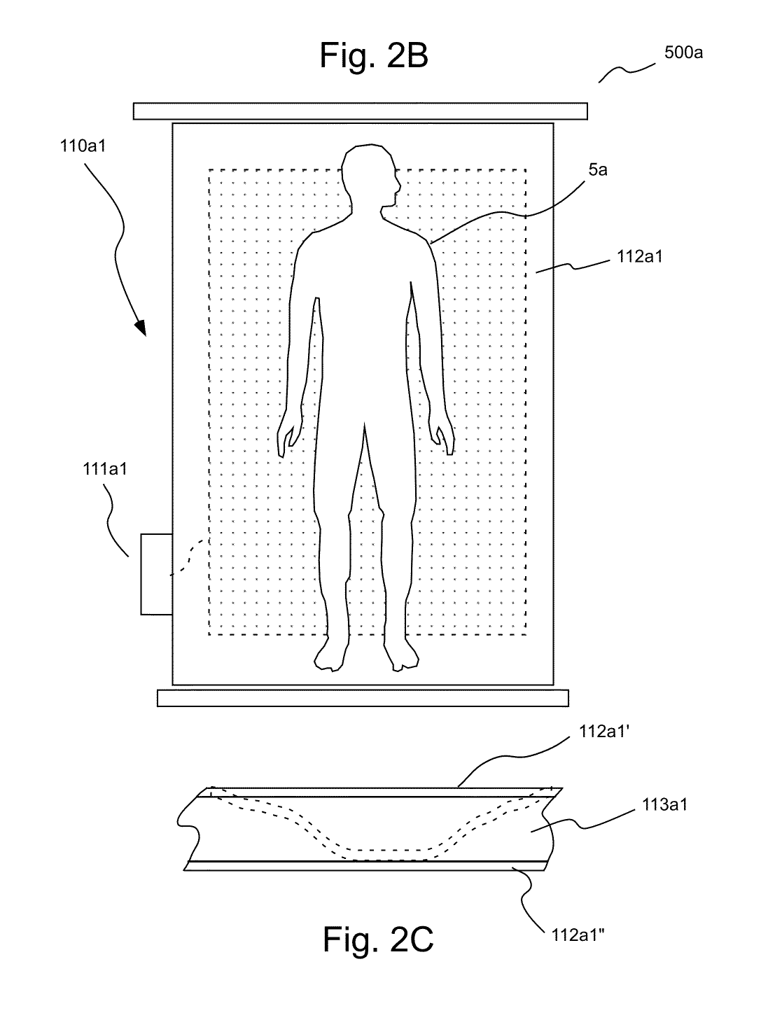

A representative embodiment of a presence sensor system 110a1, as used in connection with a bed 500a of resident 5a (and/or in connection with beds 500b . . . 500n of other residents 5b . . . 5n), is illustrated in FIGS. 2A through 2C. Sensor system 110a1 as illustrated in FIG. 2A is also representative of the configurations of other sensor systems hereof. As, for example, illustrated in FIG. 2A, sensor systems hereof may include at least one sensing or measuring system 112a1, at least one processing system or processor 114a1 (for example, a microprocessor), at least one a memory system 115a1 in communication with processor 114a1 and at least one communication system 116a1 in communication with processor 114a1. Sensor system 112a1 is adapted or operable to measure one or more variables associated with, for example, a state or change in state of a monitored system. In the case of a presence sensor, such a state change may, for example, be a change from an off state (non-presence) to an on state (presence) and vice versa. In general, such states are predefined states or conditions which are dependent upon a system being monitored. Data measured and communicated to local data communication device 150 may, for example, include a time of onset of a state (that is, a time of change from a previous or first state to a latter or second state) and data related to the duration of the state (for example, a time of cessation of a state and/or duration of the state). Processor 114a1 may, for example, perform operations on data received from sensing system 112a1, in a manner predetermined by programming therefor which may be stored in memory system 115a1 in communicative connection with processor 114a1. Processor 114a1 communicates information or data to communication system 116a1, which is adapted or operable to transmit the information or data to, for example, local data communication device 150.

Local data communication device 150 includes at least one communication system 152 which communicates (either unidirectionally or bidirectionally) with communication system 116a1 of sensor system 110a1. In a number of embodiments, each of sensor communication system 116a1 and communication system 152 includes a wireless transceiver for wireless communication (for example, using a ZIGBEE® or other wireless communication protocol). In the illustrated embodiment, local data communication device 150 further includes one or more processors 154 and one or more memory systems 155. Processor 154 may, for example, be programmed or adapted (via programming stored in memory system 155) to process (or to further process) data from sensor systems 110a1 etc. Processor 154 may further be programmed or adapted to initiate signals to be transmitted to sensor systems 110a1 etc. such as wake up signals, data polling signals etc. Moreover, processor 154 may further be programmed or adapted to control communications between one or more communication modules of communication system 152 and one or more modules of communication system 220 of remote system 200. Although a separate local data communication device 150 is provided in a number of embodiments hereof, the functionality of local data communication device 150 can be performed, in whole or in part, by one or more of sensor systems 110a1. Moreover a plurality of local data communication devices 150 may be used.

As illustrated in FIG. 2B, measuring system 112a1 of presence sensor system 110a1 may, for example, include a pressure sensitive pad which is placed upon a bed. In a number of embodiments, pad 112a1 has two states: an on state, indicating the presence of a resident 5a in the bed, and an off state, indicating an absence of resident 5a from the bed. As illustrated schematically in FIG. 2C, pressure sensitive pad 112a1 may, for example, include a first sheet of conductive material 112a1′ spaced from a second sheet of conductive material 112a1″ by an intermediated layer of a resilient material 113a1. Upon application of sufficient force to pressure sensitive pad 112a1 (associated with the presence of resident 5a), first sheet of conductive material 112a1′ is brought into contact with second sheet of conductive material 112a1″ (see broken lines in FIG. 2C) to complete an electrical circuit. Upon removal of the force, the resilient material causes separation of first sheet of conductive material 112a1′ and second sheet of conductive material 112a1″. In other words, first sheet of conductive material 112a1′ and second sheet of conductive material 112a1″ may, for example, form a switch in an electrical circuit. Voltage and/or current may, for example, be monitored or measured to determine the on state and the off state. Other elements of presence sensor system 110a1 as described above may, for example, be housed in a housing 111a1 (see FIG. 2B). Multiple switches or sensing elements as described above (or as otherwise known in the pressure/force sensing arts) may, for example, be provided over any area of pressure sensitive pad 112a1 (for example, as a matrix or array of sensing element) to, for example, detect movement as resident 5a compresses various areas of pressure sensitive pad 112a1 or to distinguish presence of resident 5a from presence of, for example, an inanimate object. In a number of embodiments, an SBPM-05 pressure sensitive pad available from Chengdu Liren Electric Co., Ltd. of Sichuan, China was used in connection with beds. An SCPM-05 pressure sensitive pad available from Chengdu Liren Electric Co., Ltd. was used in connection with wheelchairs in a number of embodiments.

Algorithms are used to detect a person in bed and generate corresponding “on” (presence) and “off” (absence) events. In addition to the presence/absence from a bed, duration of time spent in bed, the time of going to bed, the time of waking up and the time and duration of interruptions of sleep (such as associated with the use of the restroom in the middle of the night), may be recorded. Getting out of bed at a certain time or failure to get out of bed by a certain time, for example, may be indicative of a problem requiring immediate attention. In a number of embodiments, movement in bed may also be sensed by presence sensors hereof and associated with the wellbeing of resident(s) 5a . . . 5n.

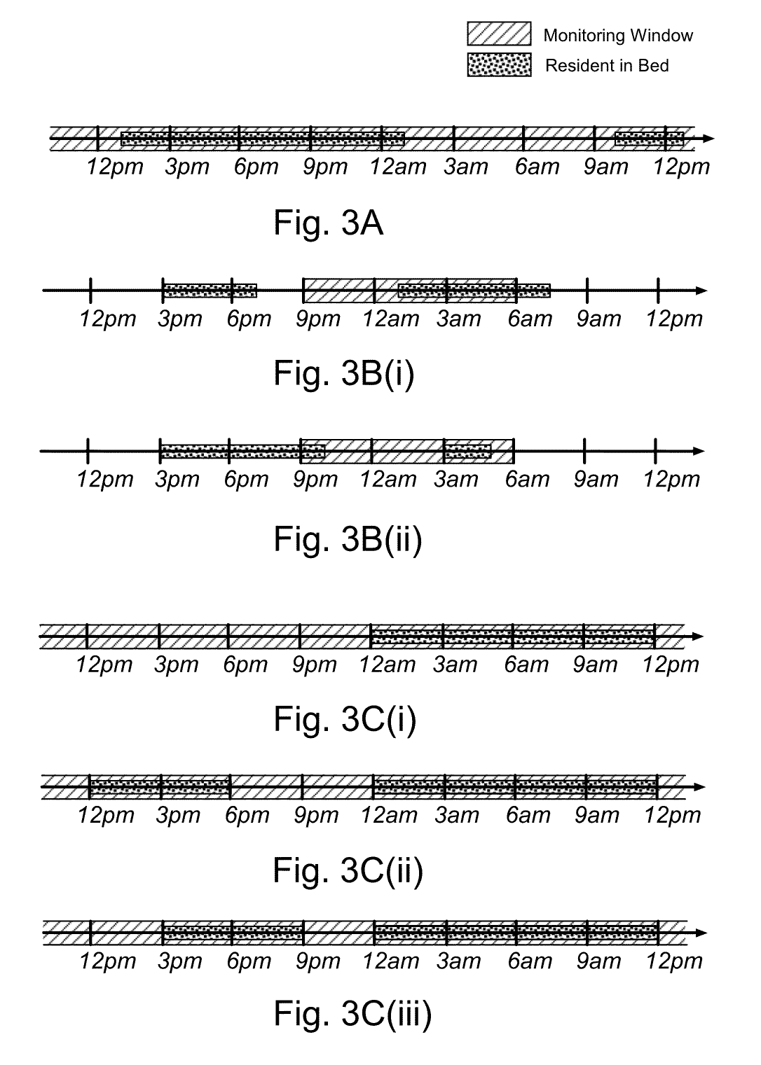

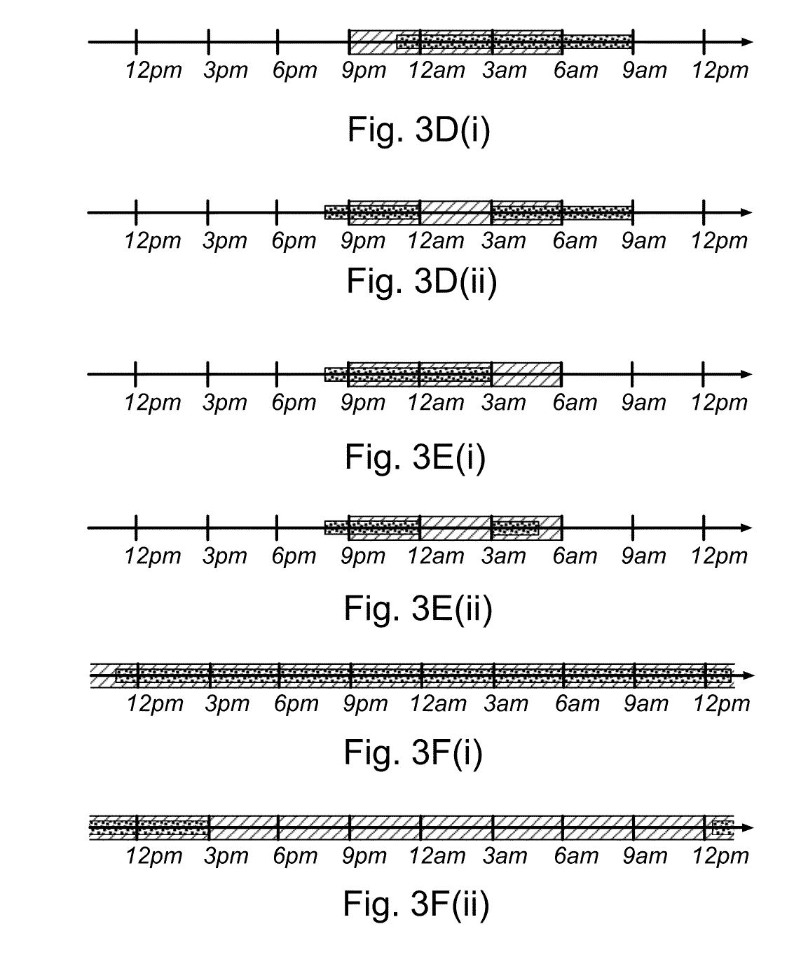

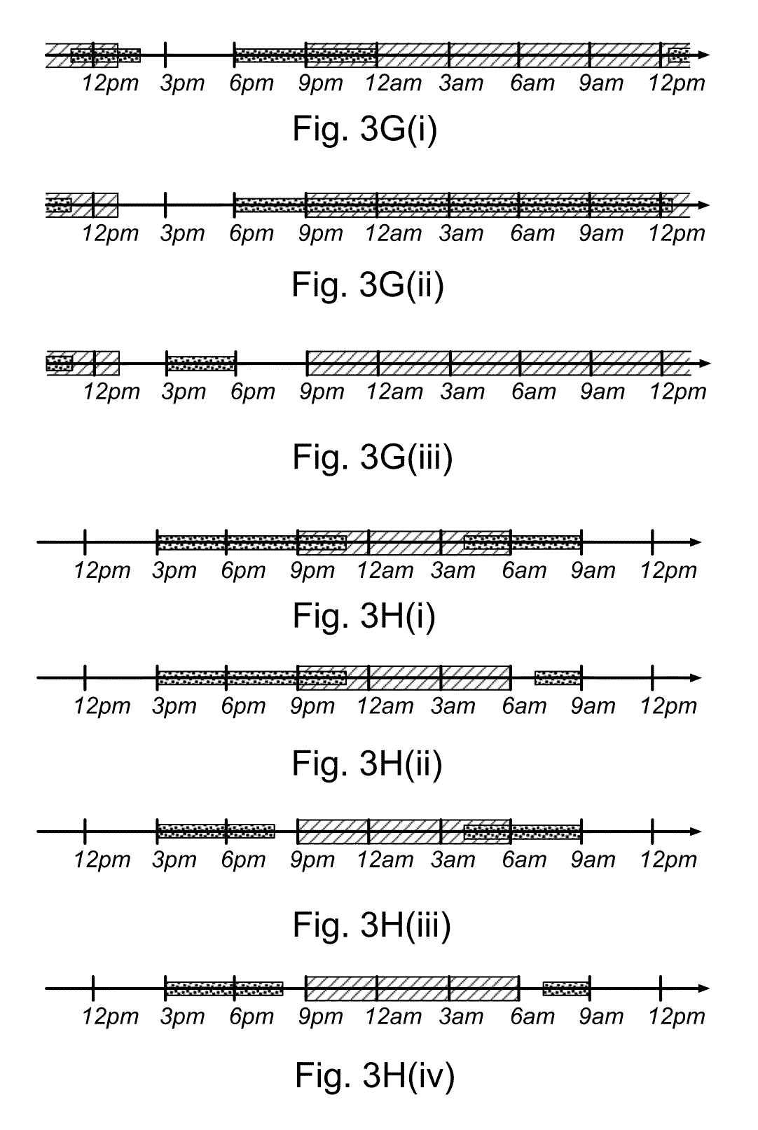

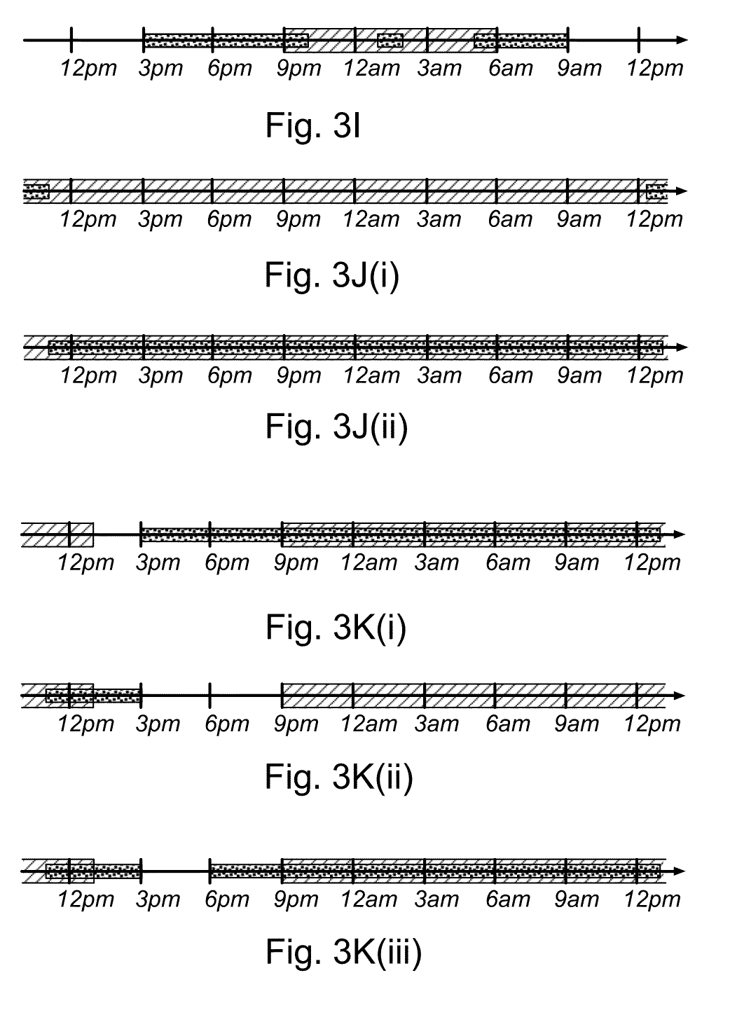

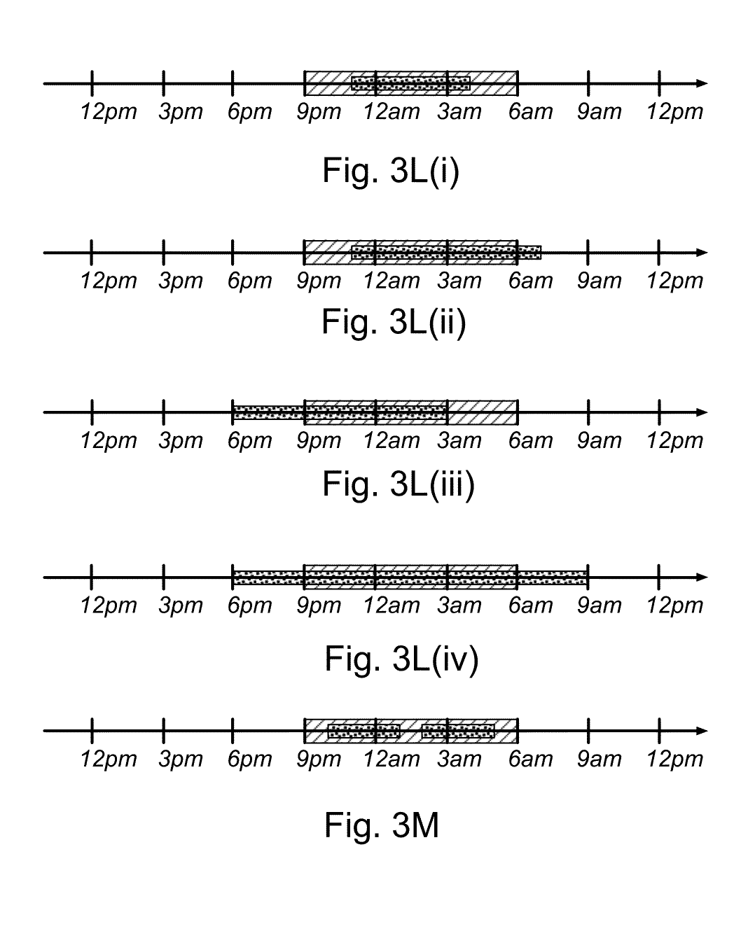

Metrics such as number of out-of-bed events, out-of-bed duration, time in bed and/or others may, for example, be determined on the basis of predetermined consecutive time periods, wherein, for each predetermined consecutive time period bed presence is monitored for a predetermined monitoring period of time or monitoring window. In a number of embodiment, the predetermined consecutive time periods are 24-hour days and the metrics are determined relative to a predetermined “sleep day” for a particular resident. A sleep day may, for example, be defined as noon of one day to noon the next day (or another 24-hour time window—such as 1 am one day to 1 am the next day) in the time zone of the resident's location. Within the sleep day, metrics may, for example, be restricted by a predefined or predetermined sleep monitoring period of time or window for the resident. Representative methodologies for determination of a number of sleep metrics are set forth below in connection with FIGS. 3A through 3M.

In determining out-of-bed or bed off events, out-of-bed or bed off events outside the sleep day may, for example, not be counted for that sleep day. For resident who is monitored 24-hours (12 pm to 12 pm), for example, in the time line of FIG. 3A, a count of 1 out-of-bed events is determined.

Multiple out-of-bed events within a rolling 10 minute window (or other user-set period) may, for example, be counted only once.

Out-of-bed events outside the monitoring window may, for example, not be counted for that sleep day. For a resident who is monitored between 9 pm and 6 am, for example, in the monitoring time line of FIG. 3B(i) a count of 0 out-of-bed events is determined. However, for the monitoring time line of FIG. 3B(ii), a count of 2 out-of-bed events is determined.

The out-of-bed duration may, for example, be limited to only out-of-bed periods occurring after the resident was in bed at least once during the monitoring window. For a resident who is monitored 24-hours (12 pm to 12 pm), for example, in the monitoring time line of FIG. 3C(i) the out-of-bed duration is 0 minutes. However, for the monitoring time line of FIG. 3C(ii), the out-of-bed duration is 6 hours, and for the monitoring time line of FIG. 3C(iii), the out-of-bed duration is 3 hours.

For a resident who is monitored between 9 pm and 6 am, for example, in the monitoring time line of FIG. 3D(i), the out-of-bed duration is 0 minutes, However, for the monitoring timeline of FIG. 3D(ii) the out-of-bed duration is 3 hours.

The out-of-bed duration may, for example, ignore the last out-of-bed period before the monitoring window ends, if the resident is out of bed at the end of the monitoring window. For a resident who is monitored between 9 pm and 6 am, for example, in the monitoring time line of FIG. 3E(i), the out-of-bed duration is 0 minutes. However for the monitoring timeline of FIG. 3E(ii), the out-of-bed duration is 3 hours.

The out-of-bed duration may, for example, be limited by the sleep day. For a resident who is monitored 24-hours (12 pm to 12 pm), for example, in the monitoring time line of FIG. 3F(i), the out-of-bed duration is 0 minutes. However, for the monitoring time line of FIG. 3F(ii) the out-of-bed duration is 21 hours.

For a resident who is monitored between 9 pm and 1 pm, in the monitoring time line of FIG. 3G(i), the out-of-bed duration is 12 hours. However, for the monitoring time lines of FIGS. 3G(ii) and 3G(iii) the out-of-bed duration is 0 minutes.

The out-of-bed duration may, for example, be limited by the monitoring window within the limits of the sleep day. Given a resident who is monitored between 9 pm and 6 am, for example, in the monitoring time line of FIG. 3H(i) the out-of-bed duration is 5 hours, while for the monitoring time line of FIG. 3H(ii) the out-of-bed duration is 0 minutes. For the monitoring time line of FIG. 3H(iii), the out-of-bed duration is 0 minutes, while for the monitoring time line of FIG. 3H(iv), the out-of-bed duration is 0 minutes.

Multiple out-of-bed durations within the monitoring window may, for example, be added up to the total out-of-bed duration for that sleep day. For example, for the monitoring time line of FIG. 3I, the out-of-bed duration is 6 hours (3 hours+3 hours).

The determined total in-bed duration may, for example, be limited by the sleep day. Given a resident who is monitored 24-hours, for example, in the monitoring time line of FIG. 3J(i), the determined total in-bed duration is 0 minutes. However, for the monitoring time line of FIG. 3J(ii), the determined total in-bed duration is 24 hours.

Given a resident who is monitored between 9 pm and 1 pm, in the monitoring time line of FIG. 3K(i), the determined total in-bed duration is 15 hours. For the monitoring time line of FIG. 3K(ii), the determined total in-bed duration is 1 hour. For the monitoring time line of FIG. 3K(iii) the determined total in-bed duration is 16 hours.

The total in-bed duration may, for example, be limited by the monitoring window within the limits of the sleep day. For a resident who is monitored between 9 pm and 6 am, for example, in the monitoring time line of FIG. 3L(i), the determined total in-bed duration is 5 hours. However, for the monitoring time line of FIG. 3L(ii), the determined total in-bed duration is 7 hours; for the monitoring time line of FIG. 3L(iii), the determined total in-bed duration is 6 hours; and for the monitoring time line of FIG. 3L(iv), the determined total in-bed duration is 9 hours.

Multiple in-bed windows within the monitoring window may, for example, be added up to the total in-bed duration for that sleep day. For example, for the monitoring time line of FIG. 3M, the determined total in-bed duration is 6 hours (3 hours+3 hours).

Monitoring sleep metrics or sleep patterns as described above may also, for example, be used to provide an early indicator of a change in a resident's condition or wellbeing. In a number of embodiments, a baseline calculation for a particular metric may be determined. For example, a cumulative distribution of the last 21 days (or other user-set period) may be established of a metric such as out-of-bed events may be determined. The cumulative distribution may, for example, exclude the most recent 2 trending days (or other user-set trending period). Items or metrics to be tracked may, for example, include number of out-of-bed events, duration of out-of-bed events and total in-bed duration. Activity or motion, as well as the level or amount of activity or motion, while in bed may also be tracked. Changes in metrics of bed use including out-of-bed events, out-of-bed duration, time in bed and, in a number of embodiments, activity in bed (individually and/or in combination) have been found to be particularly correlated with changes in patient condition. In a number of embodiments, certain events may disqualify a particular day (or other user-set period) from being counted as part of the 21 day historic window or the most recent 2 trending day window. Such events may, for example, include events wherein the resident is not in bed for the evening for more than 30 minutes or wherein the resident has been in bed for more than 20 hours in a given 24 hour period. In a number of embodiments, if the number of qualified days is less than 14 days (or other user-set period), it may be determined that there might not enough information to indicate a change in a resident's condition or wellbeing. In a number of embodiments, any of the tracked metrics for the most recent 2 trending days (or other user-set period) are compared to a user defined threshold. For example, one may track whether the metric or metrics increase by X % (a user-set threshold) or decrease by Y % (a second and separate user-set threshold), and the base change is an increase of at least Z (an absolute minimum increase to trigger the threshold) or a decrease of at least W (an absolute minimum decrease to trigger the threshold). In a number of embodiments, the resident is determined to have an unusual day if the value of the metric or metrics for the day of the most recent 2 trending days falls outside the 95% range (or other user-defined percentage) using the cumulative distribution of the last 21 days, excluding the most recent 2 days, and the metric or metrics exceeds the user defined threshold on that day. The actual range percentages may, for example, be set by the user using, for example, labels (low, medium, high) or a scale (1 to 10). In a number of embodiments, an alert will be triggered when a resident has enough qualified days and has had two unusual trending days of either the same metric and/or a combination of different metrics. Under such an algorithm or methodology, anomalous or abnormal bed/sleep behavior can be readily identified and addressed. Conditions associate with changes in bed/sleep behavior include, but are not limited to, insomnia, urinary tract conditions, medication issues, stroke, head conditions, etc.

Other types of pressure sensitive sensor systems may, for example, be used to measure one or more variables related to presence and/or movement. For example, a presence sensor as disclosed in U.S. Patent Application Publication No. 2013/0081479 may also be used in a number of embodiments thereof. Such a presence sensor systems may, for example, include one or more enclosed sensor volumes filled with a flowable fluid (for example, a flowable liquid and/or a gas). The enclosed sensor volume(s) may, for example, be enclosed by an extending member. In a number of embodiments, the extending member includes an outer layer or surface which encloses the fluid such that the sensor volume changes or compresses, resulting in a change in pressure, upon an applied external force or pressure but recovers or substantially recovers to an initial or baseline volume when the external force or pressure is removed. The outer layer or surface may, for example, have resilient properties or one or more resilient members within the sensor volume may provide resilience.

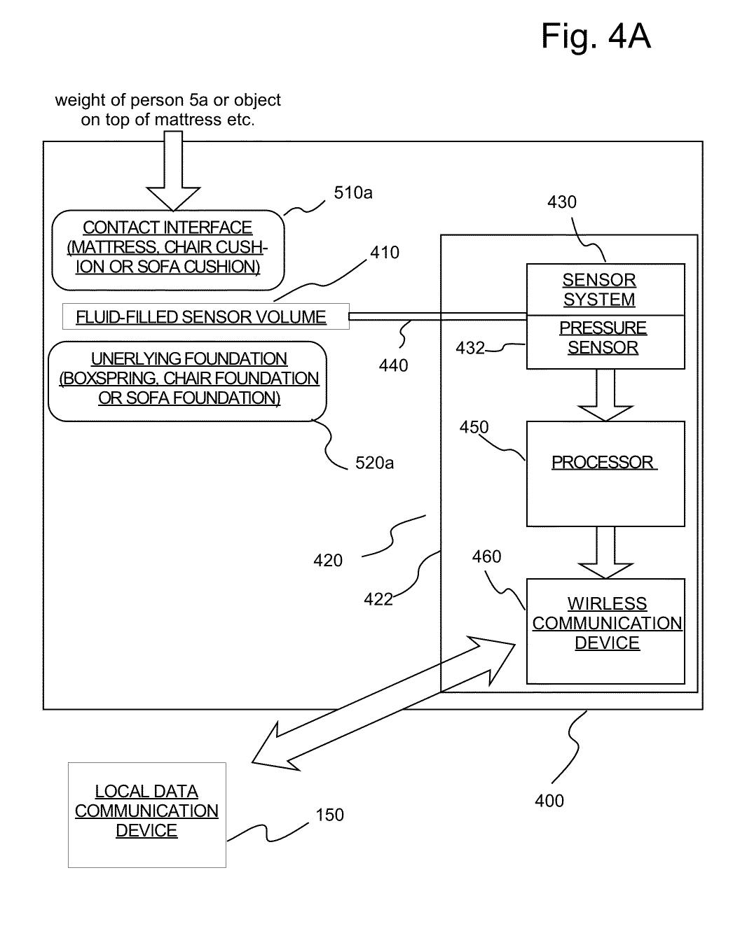

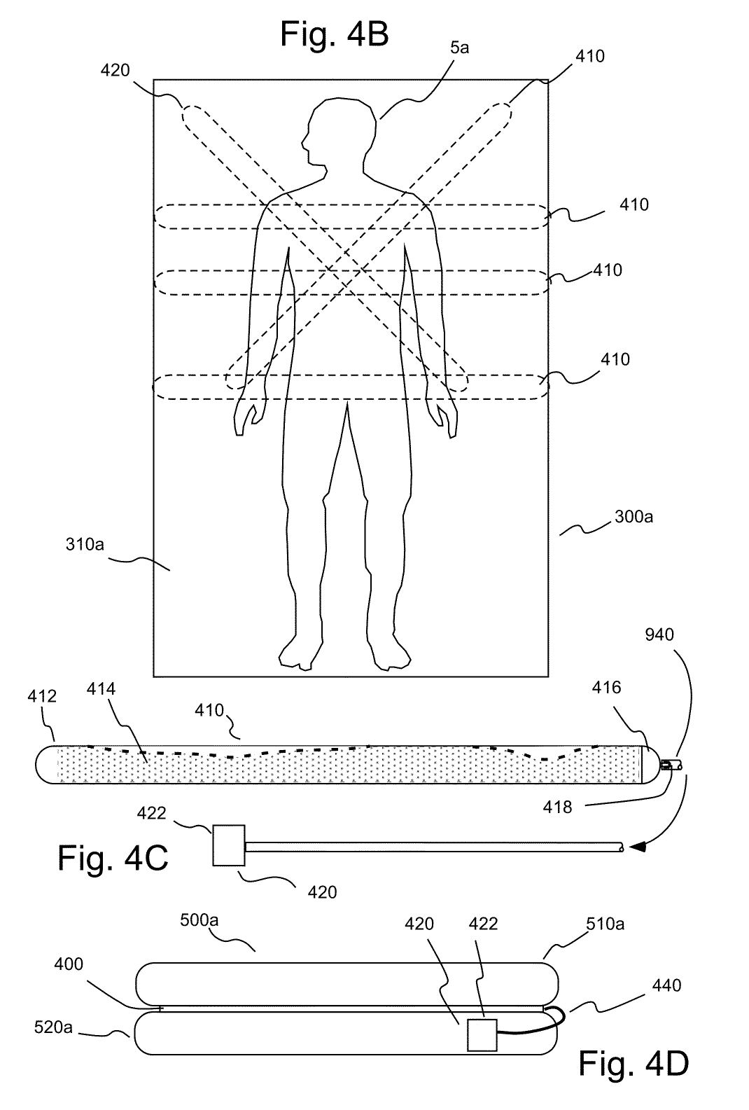

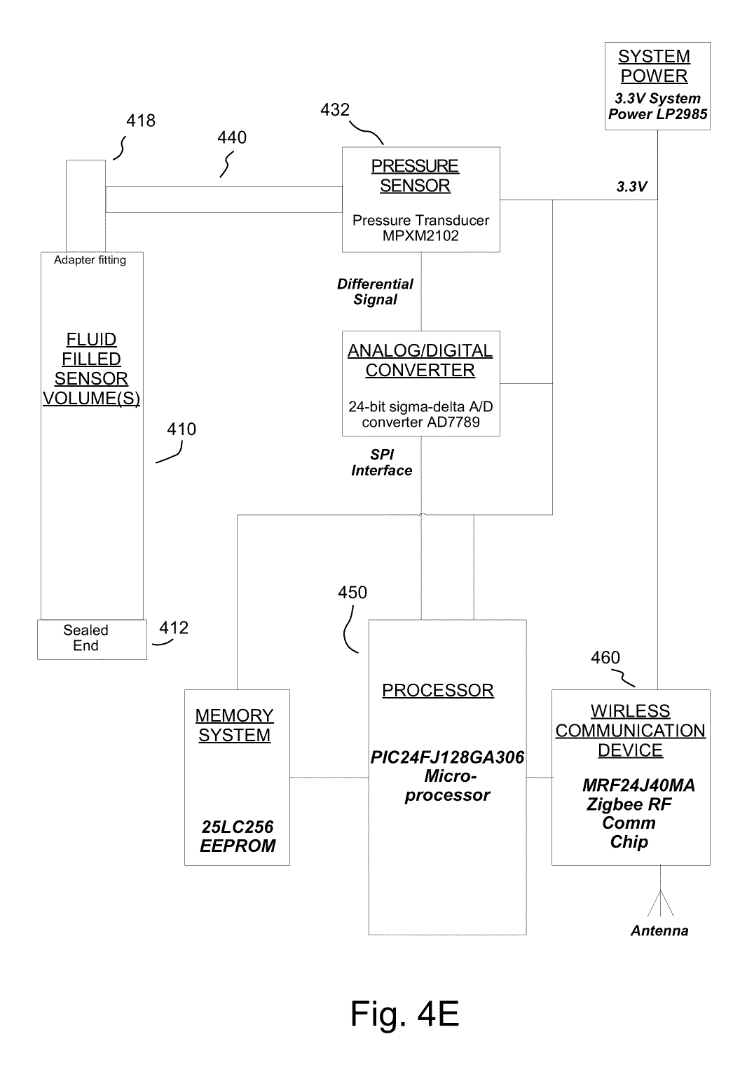

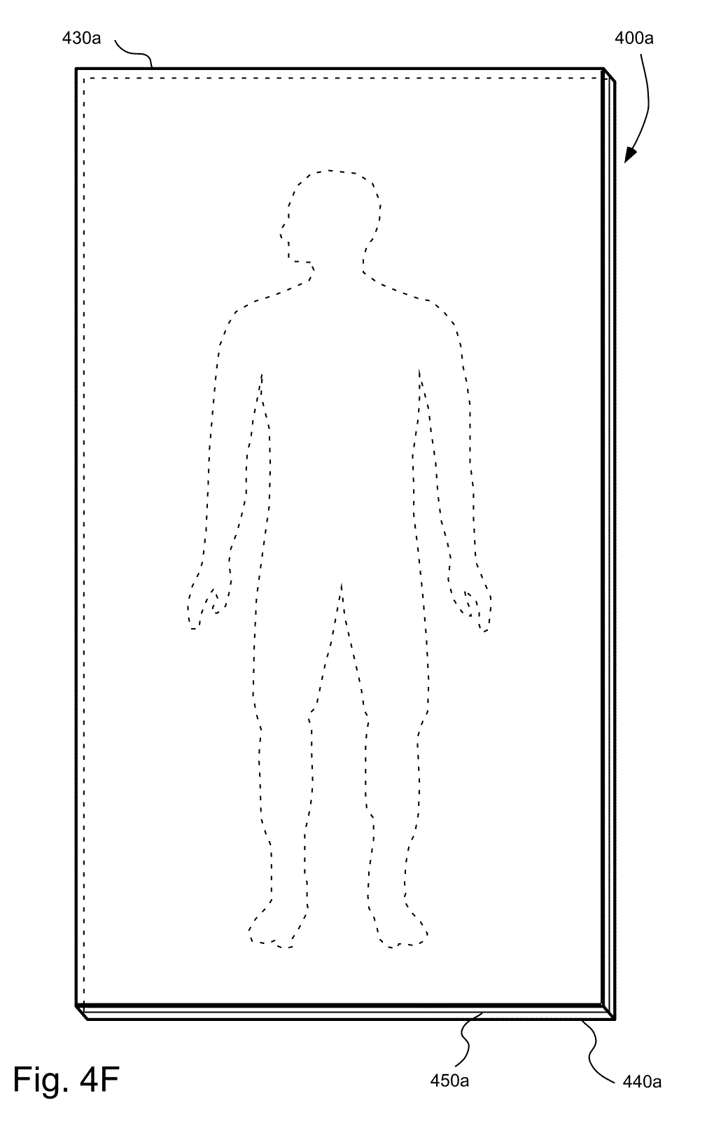

In the embodiment illustrated in FIGS. 4A through 4D, presence sensor system 400 includes one or more fluid-filled structures having a certain resiliency or spring rate. In a number of embodiments, presence sensor system 400 includes a single extending fluid-filled member or structure 410 which may, for example, be oriented in one of the orientations relative to bed 500a of resident 5a (and/or to other beds) as illustrated in FIG. 4B. As illustrated in FIG. 4D, presence sensor system may, for example, be placed between a mattress 310a and a box spring 320a. In a number of embodiments, presence sensor system 400 may include a plurality of extending members 410. Extending member or members 410 form a compressible, sealed sensing volume underneath a position on an object where person may be present (for example, directly upon or underneath pads, mattresses or other cushioning or coverings of beds, wheelchairs etc.). Extending member or members 410 may form a sensor volume of any shape, including, for example, tubes (either linear, curved or curvilinear), pads, etc.

In a number of embodiments, presence sensor system 400 uses an absolute pressure sensor which measures pressure changes in sealed extending member(s) 410. Algorithms for present detection may, for example, adapt to the “system” configuration and/or conditions and reject, for example, ambient changes in the environment.

In a number of embodiments, compression of one or more extending member 410 conveys pressure changes and other signals (for example, a flow signal) resulting from forces associated with presence and/or movement of resident 5a or an object positioned on top of the extending member 410, or an interposing pad, to a unit 420 remote from extending member 410 via an intermediate connector 430 (for example, flexible conduit). Unit 420 may, for example, include a sensor system 430 having one or more sensors including, for example, a pressure sensor or pressure transducer 432, a flow sensor, etc. within a housing 422.

Variables impacting presence sensor system 400 may, for example, be broken down into categories including: environmental, sensor system configuration, and system load. Presence sensor system 400 reacts, for example, to environmental temperature and barometric pressure changes. Such changes are detected by presence sensor system 400 as relatively slow changes that occur over periods of tens of minutes to hours and days. Temperature changes may, for example, be induced by a heating, ventilation and air conditioning or HVAC system. Presence sensor system 400 is also impacted by the extending member or members 410. For example, rigidity, which is determined by, for example, material selection and wall thickness, impacts the level of signal. Rigidity may vary from device to device. The load includes, for example, mattress 510a in the case of bed 500a. Construction and configuration of mattress 510a impacts the weight and load placed on the extending member 410. A person's sleeping position also effect the load detected by presence sensing system 400. These positions include, for example, sleeping on the back, front or side, all of which effect the weight/weight distribution placed over extending member 410.

The sensor volume within extending member 410 may, for example, form an air-filled chamber wherein the air within the chamber or sensing volume of extending member 410 is at (or approximately at) ambient or atmospheric pressure. Maintaining the fluid within the sensing volume at or near ambient pressure reduces the likelihood of leakage as compared to a system in which the sensing volume is pressurized to be at a pressure above ambient pressure. As describe above, outer layer or surface 412 of extending member 410 may, for example, be resilient and/or one or more resilient members 414 (for example, formed of a resilient material or materials and having substantial void volume) may be positioned within the sensor volume to provide resilience. In a number of embodiments, extending member 410 may, for example, be formed from a ¾″ diameter length of flexible polyvinylchloride or PVC tubing or silicon tubing having a length of approximately 4 feet (for use, for example, in connection with a bed) that was sealed at one end. The other end of extending member 410 included a seal member or plug 416, which sealed to the tube wall via, for example, an interference fit. Sealing member 416 may, for example, include a fitting 418 (for example, a barbed fitting) which is open to or in fluid connection with the sensor volume with extending member 410, and permits intermediate connector 440 (for example, a length of flexible tubing) to be affixed to and in fluid connection with the sensing volume. In that regard, intermediate connector is also in fluid connection with external or remote unit 440 so that pressure sensor 432 or transducer and/or one or more other sensor can measure the pressure within the sensing volume and monitor pressure and/or flow resulting the presence of a resident 5a and/or movement associated with the presence of resident 5a.

In a number of embodiments, one or more extending member or members 410 includes an extending “lower” or “bottom” support section or member 410a positioned on the side or area of extending member 410 generally opposite the side or area closest to placement of the load to be detected (shown in broken or dashed lines in FIG. 4C). Section 410a is more rigid than resilient layer 412 and provides support in uses wherein, for example, an adequate support is not provided below the placement of extending member 410. Such rigidity may, for example, be provided by the material characteristic of extending section 410a and/or the dimension(s) thereof. Such an embodiment may, for example, be useful in connection with certain “hospital” beds which do not include a box spring or similar component. In a number of embodiments, section 410a may, for example, be formed generally integrally or monolithically with outer layer 412 in a polymeric co-extrusion process. Such components may alternatively be formed separately and attached. As clear to one skilled in the art, many different fabrication methodologies may be used.

In the case that presence sensor system 400 includes a plurality of extending members 410, sealing members 416 thereof may, for example, be in fluid connection with a manifold system (not shown), which is in fluid connection with remote unit 440 so that a single pressure sensor can monitor pressure. Alternatively, each of a plurality of extending members 410 may be in fluid connection with a separate pressure sensor which may, for example, be housed within remote unit 440.

In a number of embodiments, intermediate connector 440 was formed from flexible polyvinylchloride tubing having a the length approximately 6 feet and a diameter less than the diameter of extending member 410. In a number of such embodiments, intermediate connector had a diameter of approximately ¼inch. The length of intermediate connector 440 may, for example, be selected to obtain specific temporal response characteristics—for example, by changing overall system volume and time constants, as dictated by specific requirements.

Pressure sensor 432 may, for example, include an absolute pressure transducer with a provisional range of 10-110 kPa. In a number of embodiments, the pressure transducer was a Freescale MPXM2102AS available from Freescale Semiconductors, Inc. of Austin, Tex., which is an on-chip, temperature compensated silicon pressure sensor with a nominal range of 10-110 kPa.

A block circuit diagram of an embodiment of the electronics of presence sensor system 400 is illustrated in FIG. 4E. In the illustrated embodiment, the pressure transducer differential output is connected directly to a 24-bit A/D converter (for example, an AD7789 A/D converter, available from Analog Devices, Inc. of Norwood, Mass.) in a ratiometric configuration, with the bridge supply and reference voltage for the A/D converter being electrically the same, which eliminates drift issues with separate references. The Analog to Digital (A/D) converter is connected to processor 450 such as a microprocessor (in a number of embodiments a PIC series microprocessor such as a Microchip PIC24FJ128GA006-I/PT microprocessor available from Microchip Technology Inc. of Chandler, Ariz.) via a (SPI/I2C) interface.

Processor 450 performs operations on the pressure data received from the A/D converter. Processor 450 transmits data/information via a wireless communication device 460 (for example, including an RF transceiver and ZIGBEE protocol) to local data communication device 150. In a number of embodiments, the RF transceiver was a MRF24J40MA-I/RM Zigbee module available from Microchip Technology, Inc., which was controlled by processor 450.

As described above, one or more fluid-filled sensing volumes such as extending members 410 is first positioned, for example, beneath mattress 310a of bed 300a. In a number of embodiments, a measuring or sensing algorithm measures the change between two pressure values and compares the change against a threshold. The compared pressure values may, for example, be averages and the threshold may be adjusted for presence sensor system 400 and it environment of operation. Sensor system 430 monitors and records baseline measurements (for example, a baseline pressure via pressure sensor 432) wherein no person in present on the bed. An amplitude around the baseline (for example, +/−10%) is defined. Any signal within the defined amplitude window will not be determined as a valid presence on bed 300a. When a pressure is measured outside of the baseline window, processor 450 will record and timestamp the measurement as the onset of presence. When the measured pressure decreases back to within the baseline window, processor 450 will record and timestamp the measurement as an end of presence. Onset of presence and end of presence may, for example, be transmitted to local data communication device 150 upon determination or may be stored by sensor system 400 and transmitted at a later time.

If a newly determined baseline is within a certain percentage (for example, within 20%) of the previously determined baseline, the new baseline may, for example, be averaged with previous baseline measurement to create, for example, a rolling average for future measurements. If a new baseline is not within 20% of the previous baseline, it may indicate a problem (for example, a leak in the sealed sensing volume). Likewise, if newly measured baselines exhibit a decreasing trend for a certain period (for example, for 5 days), this may indicate a leak. In such conditions, processor 450 may, for example, cause communication of a signal to local data communication device 150 to cause an upload to remote system 200 to cause an alert or a notice to check for leaks in the sensing volume of presence sensor system 400 or one or more other problems.

Presence sensor system 400 may also be used for detection of motion of resident 5a (or another resident) after sensing presence as described above. Sensing of motion may, for example, be used to validate that a person rather than an inanimate object is resting on an item or to monitor status of a resident that is present on the item (for example, bed 300a). Motion/movement of a resident may, for example, be associated with various conditions of the resident as discussed further below. As set forth in FIG. 4G, sensor system 900 may, for example, monitor and record baseline pressure variation by measuring peak pressure, root mean square (rms) pressure and/or other value(s) over a predetermined period of time. When a load outside the baseline window is measured as described above, an onset of presence is determined Variation in the load (for example, as measured by pressure variation) is measured over time. The measured variation during presence may be compared to baseline variation values. In a number of embodiments, if a ratio of >1 is determined, this determination is associated with validation of the presence of a person. If the ratio is ≦1, the comparison may, for example, be run for n additional cycles, wherein n is an integer. If n additional cycles are completed with no presence to baseline ratios >1, the presence is flagged as not a person (that is, as a static load such as laundry etc.).

In a number of embodiments, if presence is initially detected and validated as a person for a certain period of time (for example, greater than x wherein x is, for example, 1-2 hours), and, subsequently no motion is detected for a define period (for example, greater than y wherein y is, for example, 1 hour), but measured DC pressure remains the same, this measured lack of motion may be indicative of an emergency condition of resident 5a. Moreover, lack of movement of resident 5a may be predictive of the potential for development of bed sores, necessitating action by a caregiver.

In a number of embodiments, average upper and lower (or average minimum and maximum) pressure measurement are determined by presence sensor system 400 and adaptively updated as, for example, described above. For example, over a period of time (for example, several days) the system 400 monitors and/or records pressure and determines a minimum/lowest average pressure and a maximum/highest average pressure. In a number of embodiments, a threshold was mathematically derived to distinguish between presence of resident 5a (or another resident) and absence of resident 5a (or another resident). In a representative example, a threshold change was determined (for example, via processor 450) as a percent of the delta or difference between the minimum average pressure and the maximum average pressure (for example, x %*(max−min)). In such a representative embodiment, if the minimum average pressure was, for example, determined to be 1 psi and a maximum average pressure was, for example, determined to be 10 psi, the threshold change would be 0.2*(10−1) or 1.8 psi. The threshold or decision point between presence and absence would be determined as the minimum average pressure plus the threshold change or 1 psi+1.8 psi=2.8 psi. Thus, 2.8 psi would be set as the threshold or decision point, wherein a pressure less than 2.8 psi would be determined to correspond to absence, and a pressure of greater than 2.8 psi would be determined to correspond to presence. Some variation or hysteresis may, for example, be provided around the threshold pressure before a change of state is determined (for example, 0.5 psi). As clear one skilled in the art from the disclosure hereof, many different types of algorithms may be used to determine, for example, a threshold or decision point during use of system 900.

In another embodiment of an algorithm or methodology, pressure in extending member 910 was sampled with a 24 bit A/D every one second, and averages were generated over a defined period of time. These averages were stored in a ring buffer of the memory system. In a number of representative embodiments, three windowed averages were generated. The three windows were 15, 60, and 15 seconds in size and were end-to-end windows. The outer or 15 second averages were differenced to calculate changes in pressure or deltas (Δs). The deltas were compared against a threshold to determine (in the case of a bed) an “on bed” or “off bed” state or state change. The threshold was calculated via an adaptive algorithm. In that regard, the algorithm stored the maximum delta for each of the last three days. In addition to the three days, a history value was calculated. The history value was calculated/updated by multiplying the current history value by 3 and adding the current day's peak value and dividing by 4. The three daily averages and the history value were averaged together. The threshold was the set to equal to 50% of the resulting average.

HVnew=(3*HVₚᵣₑᵥᵢₒᵤₛ+DV)/4

Threshold=0.5*((D1+D2+D3+HVnew)/4)

wherein HV=history value; DV=daily peak value for the current day; D1=current day peak; D2=yesterday's peak value and D3=peak value from two days ago. The algorithm or methodology is summarized as follows:

a. Generate 1 second sampled;

b. Calculate average 1, samples s[n]-s[n−14];

c. Optionally, calculate average of 60 second window;

d. Calculate average 2, samples s[n−75]-s[n−89];

e. Subtract average 2 from average 1=delta;

f. Compare delta to threshold;

g. Generate ON or OFF event; and

h. Process delta for generating daily max delta.

As described above, once presence has been determined, system 400 may continue to monitor pressure to look, for example, for relatively small variations in pressure corresponding to movement and/or physiological parameters associated with pressure changes. As described above, the variation in pressure may, for example, be compared to variations in the minimum or baseline pressure. As clear to one skilled in the art, other algorithms to determine movement may be used. If, for example, a pressure of 8 psi is measured and is subsequently relatively constant, the measurement may be associated with the presence of an inanimate object such as a suitcase. If, for example, the pressure varies from 7 to 9.1 psi, the pressure variation may be associated with movement, validating the presence of a person. If a measured pressure associated with presence is maintained, but movement/pressure variation ceases, the cessation of movement may be associated with a problem and an upload upon exception may be initiated.

As describe above, system 400 is adaptive or learns over time. Because no thresholds (for example, associated with presence, movement etc.) are preset or established for system 400 is placed in us, but determined over time and adjusted thereafter on the basis of measured parameters, system 400 may for example, adapt to various changes (for example, a change in weight of person 5). Likewise, system 400 readily adapts to a change in mattress type or cushion type or to being placed in operative connection with a different item (for example, a new bed).

In a number of embodiments, sensor system 400 may also or alternatively be used to monitor clinical items such as heart rate, respiratory rate, movement in general (something in bed, something in bed moving, something in bed within expected limits of a person, physiological parameters) etc. Such items cause measurable pressure and/or flow variation. Sensor system 400 can also be used to trend weight changes over time.

FIG. 4F illustrates another embodiment of a presence sensor 400a in which electrical resistance properties of a resistive ink is used to detect presence as well as activity/motion while a person is present, for example, in a bed. In the embodiment of FIG. 4F, presence sensor 400a is dimensioned as a pad for use in connection with a bed. Presence sensor 400a includes a first generally rectangular-shaped sheet of material 430a (for example, a polymeric insulating material such as MYLAR, which is a stretched, flexible polyethylene film available from E.I. Du Pont De Nemours and Company of Wilmington, Del.) and a second sheet of material 440a (for example, a polymer insulating material such as MYLAR) separated by, for example, an intermediate layer 450a including thin strips of a foam insulating material (for example, a polymer foam). The foam layer 450a provides separation between first sheet 430a and second sheet 440a. Gaps between the foam strips of intermediate layer 450a allow the first sheet 430a and the second sheet 440a to make contact when a person is lying on presence sensor 400a. The sides of first sheet 430a and second sheet 440a facing the intermediate layer 450a include, for example, a resistive ink thereon that provides an electrical path when first sheet 430a and second sheet 440a come in contact with each other.

In a number of applications, presence sensor 400a simply forms an electrical switch. When a person lies on presence sensor 400a, the switch closes as described above, and an electrical current flows through the circuit created by presence sensor 400a. This closed circuit is detected by an attached bed monitor similar to that described above in connection with presence sensor 400. When a person gets up, the switch opens, and the current stops flowing. The resistive properties of the resistive ink used to form electrical contact in presence sensor 400a can be exploited to determine presence as well as activity/motion when present. In that regard, the resistance of the electrical connection made by presence sensor 400a can be monitored. The resistance increases or decreases depending on the position where contact is being made. One can therefore detect resistance changes over short periods of time and determine if a person is moving while present. In-bed activity can, for example, be used to determine a number of conditions such as risk of pressure ulcers (bed sores), urinary tract infections etc.

As described above, monitoring bed presence and sleep metrics or monitoring wheelchair usage may be used for fall protection in the case that an out-of-bed event or an out-of-wheelchair event is sensed. Moreover, as not all residents behave the same or present the same care requirements, system 50 may provide for different sensitivity settings for each resident or for groups of residents. Sensitivities/parameters for a particular residents may, for example, be set so that the resident can get out of bed (for example, to go to the bathroom and get back to bed without a caregiver being alerted. If, however, this resident were to fall or take too long in getting back to bed, the caregiver could be alerted. For particularly fragile residents, an alert may, for example, be generated for any out-of-bed event. Sensitivities/parameters may, for example, be individually set for metrics including, but not limited to, time out of bed, time in bed, number of times out of bed, time of toing to bed, and time of getting up.

Further, a hierarchy of settings from “facility wide” settings to “location specific” settings to “business unit” settings and then “resident specific” settings may be provided. The user may, for example, set such default settings and then may, for example, set specific settings for locations and/or for residents.

Monitoring sleep metrics or sleep patterns as described above may also, for example, be used to provide an early indicator of a change in a resident's condition or wellbeing. In a number of embodiments, a baseline calculation for a particular metric may be determined. For example, a rolling average of last 14 days (or other user-set period) of a metric such as out-of-bed events may be determined. Items to be tracked may, for example, include number of out-of-bed events, duration of out-of-bed events and total hours of sleep. Certain events may disqualify a particular day from being counted as part of the 14 day rolling average. For example, such events may include if the resident is not in bed for the evening for more than 30 minutes and if the resident has been in bed for more than 20 hours in a given 24 hour period. In a number of embodiments, if any of the tracked metrics increase by X % (a user set threshold) or decrease by Y % (a second and separate user set threshold), and the base change is an increase of at least Z (an absolute minimum increase to trigger the threshold) or a decrease of at least W (an absolute minimum decrease to trigger the threshold), then an alert will be triggered.

As set forth above, monitoring movement during bed presence may be used to predict and prevent the occurrence of bed sores. A bed sore occurs when blood supply is cut off to a particular set of tissue for two hours or more, which typically occurs when a person does not move from a specific position within that period of time. Current methodologies of preventing bed sores include manual inspection and turning the person regularly. Presence sensor hereof such as presence sensors 110a1 . . . 110an and presence sensor 400 can measure activity and/or movement in bed. If only limited or no movement is detected within, for example, a two-hour period, system 50 may notify/alert a caregiver that a resident is at risk of experiencing bed sores, and that the caregiver needs to address the situation.

Response time is an important parameter for alerting a caregiver of a resident who may, for example, be getting out of bed or out of a wheelchair and is about to fall. The response should be as rapid as possible. A networked system such as system 50 typically transmits a signal/data from a particular presence sensor to remote system 200, wherein a determination is made as to whether an alert is warranted. If an alert is warranted, remote system 200 transmits the alert via communication device 150 to the appropriate receiving party. The associated transit time delays the arrival of the alert and, ultimately, delays the receipt and resultant action that prevents a negative result.

Although a purely local system may, for example, provide for rapid response time, such local systems do not have the ability to provide smart logic, communication tree logic or data tracking that is available with a networked solution. System 50 combines a networked and a local system. By utilizing, for example, a ZIGBEE and/or other proprietary communication protocols, system 50 may, for example, dispatch an (nearly) instantaneous alert to a caregiver while still collecting the data and generating long term alerts and analysis at remote system 200. This hybrid configuration offers the best of both worlds.

Alerts may, for example, set online (via remote system 200) using logic that may, for example, be employed across groups of monitored individuals or for one specific person. Such alerts are based upon monitored behavior such as getting up at night. The alerts typically involve logic such as, alert me if resident X gets up between 7 PM and 7 AM and is up for more than 5 minutes. In the case of a localized solution and local alerts (for example, if communication was lost between local system 100 and remote system 200), such alerts from remote system 200 would not apply. Local system 100 may, for example, apply local alerts in such a situation. For example, the caregiver may be notified immediately for any change in status. In other words, the logic provided by remote system would not be applied, and remote system 100 may provide a local alert when any status change is detected.

Through triangulation, system 50 may also give an indication of location of a particular sensor at the time of the alert. Typically triangulation requires a plurality of communication devices positioned at different positions. Even in the case of a single local communication device 150, however, signal strength may, for example, be used to provide an approximate distance from local communication device 150. That in itself is not really triangulation. This location information helps the caregiver respond rapidly to a mobile resident who may need help. By providing a 2-way capability, at the local alert level, as further described below, the system may collect data and transmit a follow-on alert only if confirmation of receipt of a local alert by a caregiver has not been received within a reasonable period of time. Moreover, because system 50 is both local based and networked, any loss of network connection need not interfere with localized alerts. Once the connection between local system 100 and remote system 200 is regained, all communication and data may be immediately uploaded.

As indicated above, there is a need in assisted living facilities and skilled care facilities for an alert system or paging system that quickly or immediately alerts one or more caregivers when an incident has occurred or is about to occur. For example, a resident may exit from a bed or a wheelchair and becomes an immediate fall risk. A presence sensor system such as sensor system 101a1 or sensor system 400 may, for example, be used in connection with a wheelchair to determine when a resident such as resident 5a exits from a wheelchair and becomes a fall risk (see, for example, sensor system 110d1 in FIG. 1B). In such an alert system or paging system, there is also a need for a caregiver to provide a quick and simple confirmation that an alert was received and that the caregiver is attending or will attend to the resident.

Current one-way pager systems use short-range wireless communication to send messages to pagers. However, the messages can be sent only one way (that is, from a base station to a pager), and thus cannot be acknowledged by the recipient. Currently available two-way pager systems provide a means for a recipient to reply to a message. However, such two-way systems use the cellular phone infrastructure, which can add considerable delay and cost to message transfer. In addition, one typically must interact with the pager by typing a text message using a miniaturized full keyboard. This method is too complex for a caregiver, who must focus his or her attention on attending to the immediate needs of residents.

The above and other problems are overcome by using short-range wireless technology for pager communication while providing a simple interface (for example, a two-button interface) for acknowledging alerts. All equipment may, for example, be located within the assisted living facility or skilled care facility and does not rely on, for example, a cellular phone infrastructure or an existing IT network.

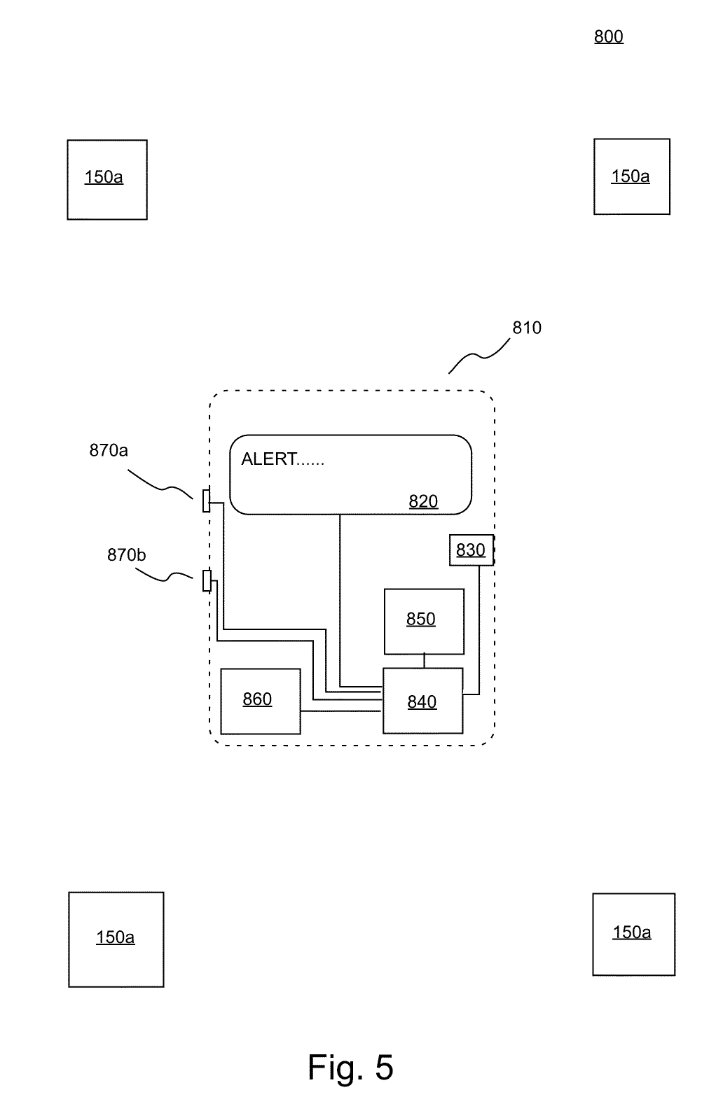

An embodiment of a pager system 800 as illustrated in FIG. 5 includes one or more wireless communication hubs 150a that receive and parse messages from sensor systems such as sensors 110a1 . . . 110an, 110b1 . . . 110bn, 110c1 . . . 110cn, 110d1 . . . 110dn, 110e1 . . . 110en, 110f1 . . . 110fn, 110g1 . . . 110gn. Communication device or hubs 150a may, for example, operate in the manner of local communication device 150. Messages may, for example, be received over a short-range wireless communications medium such as IEEE 802.15.4, ZigBee, ad-hoc Wi-Fi, or a proprietary protocol in one of the unlicensed Industrial, Scientific, and Medical (ISM) bands via a wireless communication interface 860 in pager device 810 worn by a user. Textual messages may, for example, be displayed on a display 820, which is in communicative connection with a processor 840 (for example, a microprocessor). An audible and/or tactile alert may also be provided to a caregiver via an alarm 830. When a communications hub 150a receives a sensor system message that a resident has exited a wheelchair, it broadcasts an alert to all pager devices 810 using the same wireless medium.

A caregiver may, for example, respond to the alert using a sequence requiring at least two independent actions. The sequence may, for example, be a simple button sequence, such as pressing two buttons 870a or 870b simultaneously or sequentially in a predefined order. Requiring a sequence of at least two independent action, assists in preventing a false acknowledgement. Upon carrying out the required sequence of actions, an acknowledgement message is transmitted back to the transmitting communications hub(s) 150a, indicating that the alert was received and a response is being made. Communications hub 150a may then broadcast a message to all pager devices 810 indicating that a response is underway.

Via location of a pager device, the systems hereof may also determine if a paged caregiver has responded to an alert. For example, a caregiver equipped with pager device 810 may have been sent an alert regarding resident 5b. Proximity of the caregiver's pager 810 to and communication of the pager with components of the local system for example, within the room of resident 5b in a certain timeframe may be used to provide acknowledgement that the caregiver has responded to the alert. In a number of embodiments, the pager devices hereof may, for example, transmit a response automatically (that is, without user intervention) when it comes into close proximity with, for example, a sensor that initiated the alert caused by activity or lack of activity of a monitored person or with other communicative components of the systems hereof in the vicinity of the monitored person who is the subject of an alert. The pager device may, for example, transmit a very low power beacon upon receiving an alert. When the beacon is received by, for example, the sensor that initiated the alert, a response is transmitted to the local communication device indicating that the caregiver associated with the pager affirmatively responded to the alert

Communications hub(s) 150a may, for example, re-send alerts that have not been acknowledged within a particular timeout interval. Such resend may, for example, be periodically repeated until a response is made from a caregiver. Communications hub(s) 150a may also broadcast certain maintenance and status messages to pagers, such as sensor system low battery conditions or sensor systems losing wireless contact with communications hub(s) 150a.

Communications hub(s) 150a may also send activity data (alerts and responses) to remote system 200 for logging and reporting purposes.

In a number of embodiments, communications hub(s) 150a may send an alert to a caregiver who is closest to the resident who is the subject of the alert. The closest caregiver may, for example, be determined by measuring signal strength, which is proportional to proximity to communications hub 150a. Triangulation may, for example, be used to give an approximate location of the resident who is the subject of the alert. In a number of embodiments, the closest caregiver may take action to accept or decline/pass on the alert. If the caregiver does not response within a certain period of time or declines the alert, then the system may send the alert to the next closest caregiver, and so on. Hierarchical rules for choosing a particular caregiver to whom to provide an alert may include rules or considerations (for example, skill set, etc.) in addition to or other than proximity.

In a number of embodiments of the systems and methods hereof, an array or network of sensor systems operate in concert with each other and data therefrom is correlated such that the wellbeing of the monitored person can be tracked and exceptions and/or alerts can be generated based upon events or values from multiple sensor systems or parameters, tracked in parallel. The data for a plurality (including at least two) sensor systems is thus monitored and correlated using predetermined rules and/or logic to determine if the combination of data from the plurality of sensors indicate the need for an alert. More accurate alerts are thus possible over the case of non-correlated data from individual sensors.

Several types of representative sensor systems for use in the systems hereof are discussed in further detail below. One type of sensor system used in the systems hereof is an energy sensor system that can be used in connection with electrically powered devices attached to an electrical outlet in space 10. One or a plurality of sensor systems 110b1 . . . 110bn, 110c1 . . . 110cn, 110d1 . . . 110dn, 110e1 . . . 110en, 110f1 . . . 110fn, 110g1 . . . 110gn etc. may, for example, be an energy sensor system as described in U.S. Patent Application Publication No. 2012/0056746.

Various sensor systems can also be used to measure utility usage such as water usage. By, for example, measuring the water intake of a resident's quarters, water usage associated with monitored resident using the bathroom, taking showers, etc. may be monitored. Water consumption may, for example, be measured using a variety of methods including, for example, a mass flow sensor system that clips around an intake pipe and senses water flow and/or water volume consumed, a temperature sensor system that senses temperatures different than room temperature as well as other methods. Water consumption can also, for example, be measure using an acoustic sensor as described in U.S. Patent Application Publication No. 2013/0085688.

Sensor systems can also be used in connection with one or more medical devices (for example, diagnostic or treatment devices) used in connection with the monitored person's body or medical care. For example, dental CPAP appliances are sometimes used to treat persons suffering from obstructive sleep apnea. Compliance with dental CPAP device therapy is, on average, less than 60% in the United States. One or more sensors can, for example, be used to monitor persons using dental CPAP appliances, and track the hours of usage of such devices. A sensor system can, for example, be placed on the side of the dental CPAP device, which, when in use, resides in the person's mouth and senses the use of the dental CPAP device by, for example, sensing changes in temperature or conductivity in the person's mouth. The data can then be transmitted to remoter system 200 for compliance tracking purposes.

In a number of embodiments, one of sensor systems 110b1 . . . 110bn, 110c1 . . . 110cn, 110d1 . . . 110dn, 110e1 . . . 110en, 110f1 . . . 110fn, 110g1 . . . 110gn is a sensor system that is able to detect an audible alarm of another monitoring/sensor system (sometimes referred to herein as the “primary sensor system”). System 50 may be used to alert a caregiver who is remotely monitoring daily living activities of a person/resident under their care of states or state changes (that is, activation of the audible alarm of the primary sensor system) detected by the audible alarm sensor system. In a number of embodiment, the audible alarm sensor system does not need a physical connection to the primary (audibly alarming) sensor system, and, therefore, does not affect the installation, safety, or regulatory compliance status of the primary sensor system. The audible alarm sensor system may, for example, be able to learn certain characteristics of the audible alarm of the primary sensor system. Once calibrated, the audible alarm sensor system is able to reliably discern the audible alarm of the primary sensor system from interference and background noise. The audible alarm sensed by the audible alarm system may come from one of many different primary sensor systems including, but not limited to, a medication dispenser, an oven timer, a smoke detector, or CO₂ detector.

The characteristics (for example, tone, frequency, amplitude, pulse characteristics, etc.) of the sound emitted by the audible alarm of the primary sensor system need not be known in advance or comply with any known signaling standard. Likewise, the tones need not be a pure tone (for example, sine wave), and may include artifacts and/or overtones. The alarm signaling characteristics can change and still be detected (for example, a medication dispenser that beeps continuously for 30 minutes, then provides a reminder beep once per minute). There is no requirement to create a predefined template for matching with the audible alarm of the primary sensor system. The audible alarm sensor systems hereof can function as a sensor system within system 50 or can function as a standalone system wherein the audible alarm sensor systems are adapted to inform a remote caregiver of alarm on/off conditions via, for example, landline, cell phone, the internet etc.

In general, audible alarm sensor systems hereof are placed sufficiently near the primary sensor system so that a sound sensor or a microphone (that is, an acoustic-to-electric transducer or sensor that converts sound into a signal) of the audible alarm sensor system may continuously sample audio signals from the primary sensor system. The audio signals may, for example, be grouped into frames and digitized by a microprocessor. Both frequency and signal energy may be measured. In a number of embodiments, a histogram of power spectral density vs. frequency is computed. To sense an “alarm on” condition, the audible alarm sensor system, may, for example, determine a certain percentage of the power spectral density contained in the frequencies of interest, for a certain number of frames, within a certain time window. The percent power spectral density, the number of frames, and the time window interval may, for example, all be configurable. To sense an “alarm off” condition, the audible alarm sensor system may, for example, determine that there is no power spectral density contained in the frequencies of interest for a number of frames in a second time window. The number of frames and time window interval of the alarm off condition may, for example, be separately configurable from the alarm on condition. To determine the frequencies of interest, the device may, for example, be placed in a calibration mode. In the calibration mode, the alarm condition may be created (for example, by pressing a test button on the primary sensor system). The audible alarm sensor system then monitors the alarm and, for example, selects the two frequency bins that contain the highest power spectral density.

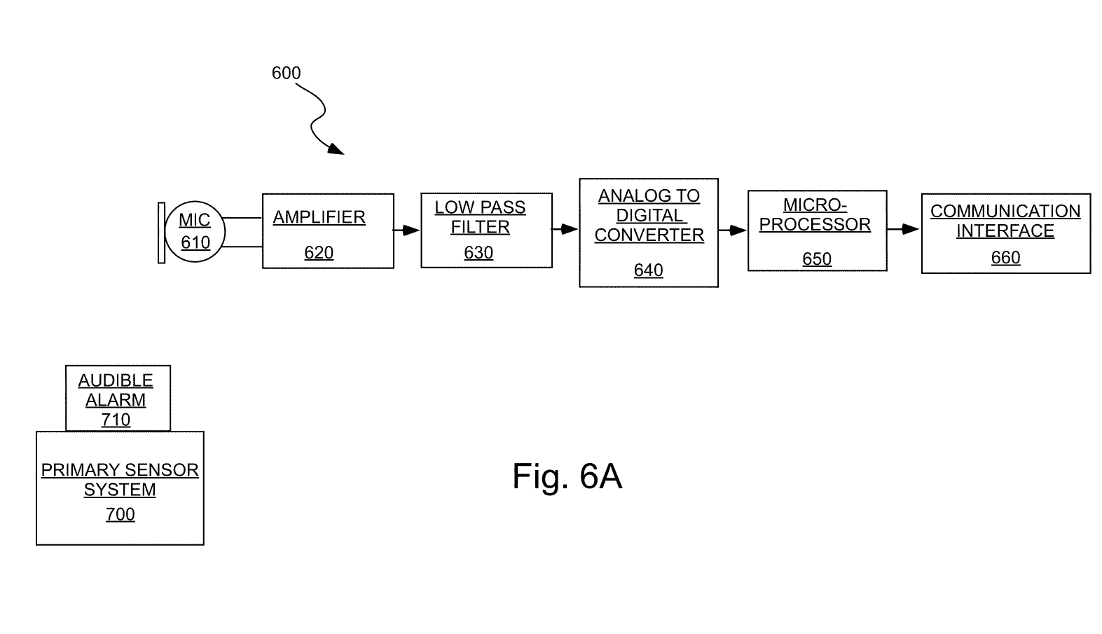

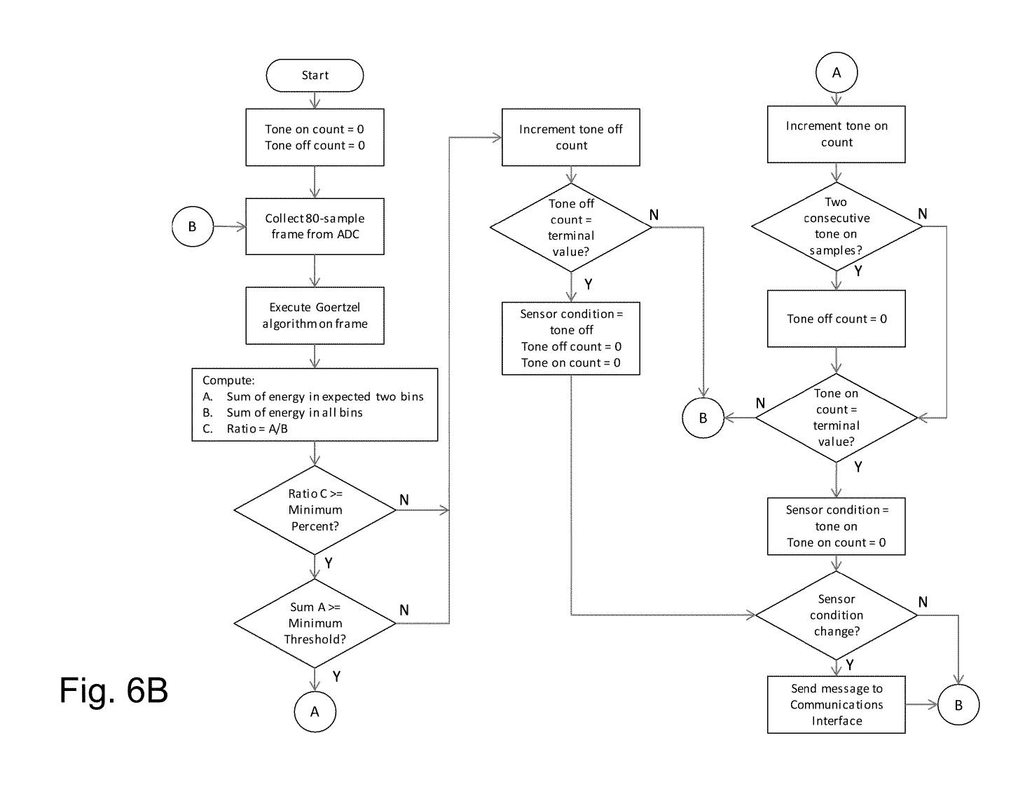

As, for example, illustrated in FIG. 6A, a representative embodiment of an audible alarm sensor system 600 hereof is position in the vicinity of a primary sensor system 700 including an audible alarm 710. As illustrated schematically in FIG. 6A, a microphone 610 continuously monitors for an alarm condition and converts its received sound into an electrical signal. The electrical signal is amplified via amplifier 620 and passed through a low pass filter 630. Low pass filter 630 is operable to remove high frequency components that may cause aliasing. The amplified and filtered signal is digitized using an analog-to-digital converter (ADC) 640. ADC 640 samples the audio signal at, for example, an 8 KHz rate, which allows the device to detect frequencies up to 4 KHz (a typical upper limit of alarm tone frequencies). Low pass filter 630 prevents frequencies above 4 KHz from being aliased into the digitized data and causing distortion. The digitized samples are passed to a processor such as a microprocessor 650 for processing.

FIG. 6B illustrates a flowchart for a representative embodiment of the digital processing that takes place. Within microprocessor 650, the digitized data is grouped into, for example, frames of 80 samples each. The frequency spectrum of each frame is analyzed using, for example, the Goertzel algorithm (which is a digital signal processing or DSP technique that provides for efficient evaluation of individual terms of the Discrete Fourier Transform or DFT first described by Gerald Goertzel). This algorithm is a well-known technique used for detecting single frequency tones. It is computationally simpler to the more popular Fast Fourier Transform (FFT), and can be tailored to specific frequencies of interest. With an 8 KHz sample rate, and a frame size of 80 samples, the Goertzel algorithm in audible alarm sensor system 600 can, for example, detect frequencies centered at 100 Hz intervals (or “bins”) from 0 to 4 KHz. In a number of embodiments, high frequency tones were targeted, and the algorithm was used to analyze tones in 19 bins from 2100 Hz to 3900 Hz inclusive. Other embodiments may, for example, include a different set of frequency bins. The Goertzel algorithm may, for example, be run on each 80-sample frame, and the resulting output may include 19 values representing the energy content in each frequency bin. In a number of embodiments, a frame of 80 samples was collected and analyzed at 100 millisecond intervals (that is, 10 times per second).

Subsequently, two sums may be computed on the energy content: (1) the sum of the energy content in all bins, and (2) the sum of the energy content in two expected bins. The two expected bins may, for example, be selected during a calibration operation described below. In a number of embodiments, the ratio of the energy content in the expected bins compared to all bins is computed. If the ratio exceeds a certain percentage, then the alarm tone is considered to be present. The percentage is configurable. Moreover, it was determined experimentally that 60% provides reliable detection even in the presence of background noise. In addition, to prevent false triggering during long periods of silence, the energy in the two expected bins was required to exceed a configurable minimum threshold value.

To detect a “tone on” or “tone off” condition, two counters may, for example, be maintained. The counters are initialized to zero. During each 100 millisecond interval, if a tone is present, then the “tone on” count is incremented. If a tone is present for two intervals in a row, then the “tone off” count is reset to zero. Requiring two consecutive “tone on” counts before resetting the “tone off” count provides a high degree of noise immunity. Conversely, if a tone is not present, then the “tone off” count is incremented, but the “tone on” count is not reset. This method allows one to detect either a constant alarm tone, or a pulsed tone with different on and off periods.

The “tone on” and “tone off” counts are, for example, compared to configurable terminal values. If the “tone on” count reaches its terminal value, then the “tone on” condition is met. If the “tone off” count reaches its terminal value, then the “tone off” condition is met, and the “tone on” count is reset to zero. The terminal values may, for example, be set according to the characteristics of the alarm being detected, as illustrated by the following examples.

In a first example, an alarm tone is a repeating pulse consisting of 3 seconds on, followed by one second off One way to detect this alarm is to set the “tone on” count to 30 and the “tone off” count to 40. If the device accumulates 3 seconds (30×100 ms) of tone detection before it accumulates 4 seconds (40×100 ms) of no tone detection, then the “tone on” condition is met. When the device accumulates 4 seconds of no tone detection (without sensing the presence of a tone for two consecutive 100 ms intervals), then the “tone off” condition is met.

In a second example, an alarm tone is a repeating pulse consisting of 3 seconds on, followed by one second off. This pattern repeats for a period of time (5 minutes, for example). After the period of time, the alarm switches to a reminder beep consisting of a ½ second beep every minute. One way to detect this alarm is to set the “tone on” count to 30 and the “tone off” count to 1200. If the device accumulates 3 seconds (30×100 ms) of tone detection before it accumulates 2 minutes (1200×100 ms=120 seconds) of no tone detection, then the “tone on” condition is met. When the device accumulates two minutes (120 seconds) of no tone detection (without sensing the presence of a tone for two consecutive 100 ms intervals), then the “tone off” condition is met. The ½ second beep each minute will create 5 consecutive “tone on” counts and will therefore reset the “tone off” count each time it occurs.

When audible alarm sensor system 600 transitions from a “tone off” condition to a “tone on” condition, a message may, for example, be sent via a communications interface 660 to, for example, communication device 150 and then to remote system 200. Likewise, when audible alarm sensor system 600 transitions from a “tone on” condition to a “tone off” condition, a second message is sent to, for example, remote system 200. This procedure allows for remote monitoring of the alarm conditions of primary sensor system 700. Communications interface 650, for example, include a wireless transceiver using a Zigbee protocol as described above. Alternatively communication interface 650 may include a landline telephone, a cellular telephone, or an internet connection.

As set forth above, the two frequency bins of interest are selected by calibrating the device to the desired alarm. In a number of embodiments, audible alarm sensor system 600 is placed in calibration mode, and an alarm of primary sensor system 700 is generated (typically by pressing a test button that generates the alarm). When in calibration mode, audible alarm sensor system 700 may, for example, continuously execute the Goertzel algorithm on 80-sample frames, resulting in 19 frequency bins per frame. The number of frames processed during calibration is configurable, but may, for example, default to 400. The corresponding bins for each of the 400 frames are summed, and the bins with the two highest sums are chosen. The two bin numbers are stored in non-volatile memory and are used for tone detection until the calibration procedure is run again.

The foregoing description and accompanying drawings set forth the preferred embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A system for monitoring a plurality of persons in an assisted living facility, comprising:
a local system in the assisted living facility, the local system comprising:
a plurality of sensor systems, each of the plurality of sensor systems being adapted to monitor changes in state of at least one monitored system caused by activity or lack of activity of at least one of the plurality of persons, the plurality of sensor systems comprising a plurality of presence sensors adapted to determine at least the presence or the absence of each one of the plurality of persons on a bed thereof or on a wheelchair thereof, and
a local communication device in communicative connection with each of the plurality of sensor systems to receive data from each of the plurality of sensor systems; and
a remote system in communication with the local communication device, the remote system comprising a processing system to process data from the plurality of sensor systems based upon predetermined rules, the remote system being adapted to provide an alert to at least one caregiver, the alert comprising at least one of (i) a fall alert to at least one caregiver present at the assisted living facility via communication between the remote system and the local communication device of the local system upon determining absence of one of the plurality of persons from the bed thereof or from the wheelchair thereof; and (ii) a condition alert to the at least one caregiver present at the assisted living facility via communication between the remote system and the local communication device of the local system related to at least one metric of bed use determined by the remote system and related to a potential change in condition of one of the plurality of persons, the remote system providing for adjusting sensitivity of at least one parameter for determining if the fall alert is required or if the condition alert is required.

2. The system of claim 1 wherein the remote system is adapted to provide each of the fall alert and the condition alert.

3. The system of claim 2 wherein the remote system provides for a hierarchy of adjusting sensitivity of the at least one parameter.

4. The system of claim 3 wherein the hierarchy ranges from a facility-wide adjustment to a per-person adjustment.

5. The system of claim 2 wherein each of the plurality of sensor systems is adapted to send a periodic signal to the local communication device to provide an indication of the operability thereof, the local system being adapted to provide an alert if one of the plurality of sensor systems fails to transmit the periodic signal to the communication device.

6. The system of claim 4 wherein a determination of signal strength of the periodic signal is made to determine if the local communication device is receiving adequate signal.

7. The system of claim 2 wherein the local system is adapted to provide a local alert to at least one caregiver in at least one predetermined circumstance without the local system receiving the local alert from the remote system.

8. The system of claim 2 further comprising at least one pager device to be worn by the at least one caregiver, the at least one pager device being in wireless communicative connection with the local communication device to receive the alert.

9. The system of claim 8 wherein the system is adapted to determine the location of one of the plurality of sensors systems giving rise to the alert.

10. The system of claim 9 wherein the at least one pager device comprises a communication interface to receive signals from and transmit signals to the local communication device, the at least one pager device being adapted to transmit a response initiated by the at least one caregiver to the local communication device to confirm receipt of the alert or the local alert.

11. The system of claim 10 wherein transmittal of the response requires initiation of at least two independent steps by the at least one caregiver.

12. The system of claim 2 further comprising a plurality of pager devices, each of the plurality of pager devices being associated with one of a plurality of caregivers.

13. The system of claim 12 wherein the system is adapted to send the alert to each of the plurality of caregivers.

14. The system of claim 12 wherein the system is adapted to determine the location of each of the plurality of pager devices.

15. The system of claim 14 wherein the system is adapted to determine the location of each of the plurality of pager devices at least in part by communication between the plurality of pager devices and the plurality of sensor systems.

16. The system of claim 15 wherein the system is adapted to send the alert to one of the plurality of caregivers determined by the system via at least one predetermined rule.

17. The system of claim 16 wherein each of the plurality of pager devices comprises a communication interface to receive signals from and transmit signals to the local communication device, each of the plurality of pager devices being adapted to transmit a response initiated by the at least one caregiver to the local communication device to confirm receipt of the alert or the local alert.

18. The system of claim 15 wherein the system is adapted to determine a response to the alert by determining the position of at least one of the plurality of pager devices to be in the vicinity of the location of the one of the plurality of sensor systems giving rise to the alert.

19. The system of claim 1 wherein the at least one metric of bed use is determined on the basis of predetermined consecutive time periods, wherein, for each predetermined consecutive time period, bed presence is monitored for a predetermined monitoring period of time.

20. The system of claim 19 wherein the predetermined consecutive time periods are 24-hour days and the predetermined monitoring period of time is 24 hours or less and occurs over the same time period in each consecutive day.

21. The system of claim 20 wherein a plurality of metric including at least out-of-bed events, out-of-bed duration, and time in bed are monitored during each predetermined monitoring period.

22. A system for monitoring a plurality of persons in an assisted living facility, comprising:
a local system in the assisted living facility, the local system comprising:
a plurality of sensor systems, each of the plurality of sensor systems being adapted to monitor changes in state of at least one monitored system caused by activity or lack of activity of at least one of the plurality of persons, the plurality of sensor systems comprising a plurality of presence sensors adapted to determine at least the presence or the absence of each one of the plurality of persons on a bed thereof or on a wheelchair thereof, and
a local communication device in communicative connection with each of the plurality of sensor systems to receive data from each of the plurality of sensor systems; and
a remote system situated remote from the assisted living facility and in communication with the local communication device, the remote system comprising a processing system to process data from the plurality of sensor systems based upon predetermined rules, the remote system being adapted to provide an alert to at least one caregiver present at the assisted living facility via communication between the remote system and the local communication device of the local system, the remote system being adapted to determine at least one metric of bed use to determine if there is a potential change in condition of each of the plurality of persons.

23. A system for monitoring a person, comprising: a presence sensor system adapted to determine at least the presence or the absence of the person on a bed thereof, and a processing system to process data from the presence sensor system based upon predetermined rules and metrics of bed use to determine if there is a potential change in condition of the person, each of the metrics of bed use being determined on the basis of predetermined consecutive time periods, wherein, for each predetermined consecutive time period, presence in bed is monitored for a predetermined monitoring period of time, the metrics of bed use comprising at least out-of-bed events, out-of-bed duration, and time in bed, the processing system being adapted to execute an algorithm to determine a baseline for at least one of the metrics of bed use over at least a predetermined number of the consecutive time periods and to determine at least one of whether the at least one of the metrics of bed use varies from the baseline by a first predetermined threshold or whether the baseline varies by a second predetermined threshold.
